(19) United States
(12) Patent Application Publication
(10) Pub. No.: US 2017/0065117 A1
(43) Pub. Date: Mar. 9, 2017

(54) FOOD PROCESSING MANAGEMENT SYSTEM

(71) Applicant: DUKE MANUFACTURING CO., St. Louis, MO (US)

(72) Inventors: Robert J. Reese, Edwardsville, IL (US); Benjamin Kingbay Wann, Kirkwood, MO (US); Canyon DeVille, Lake St. Louis, MO (US); Joshua Lee Loy, New Martinsville, WV (US); Ord Lief Delaney, Vienna, WV (US); Steven M. Shei, Fort Wayne, IN (US); Rafael K. Thissen, Chesterfield, MO (US)

(21) Appl. No.: 15/341,502

(22) Filed: Nov. 2, 2016

Related U.S. Application Data
(63) Continuation of application No. PCT/US2015/029273, filed on May 5, 2015.
(60) Provisional application No. 61/988,825, filed on May 5, 2014.
(60) Provisional application No. 61/988,894, filed on May 5, 2014.
(60) Provisional application No. 62/056,260, filed on Sep. 26, 2014.

(51) Int. Cl. A47J 27/14; G06Q 50/12; G05B 19/042; G06Q 10/06

(52) U.S. Cl. CPC A47J 27/14; G06Q 10/06316; G06Q 50/12; G05B 19/042; G05B 2219/2642

(57) ABSTRACT

Systems, apparatus, and methods for food processing management. A cook list may be displayed on a master control user interface and a cooking device user interface. Food cook recipes may be selected for cooking different food types according to respective cook recipes. Transfer of cooked food from a cooking device to a food holding apparatus may be monitored for transfer delay. Cooked food subject to transfer delay may cause at least one of turbo boost heating in the food holding apparatus, denial of entry into the food holding apparatus, and requirement to cook replacement food.

### CROSS-REFERENCE TO RELATED APPLICATIONS

This application is a continuation of PCT Patent Application No. PCT/US2015/029273, filed May 5, 2015, which claims priority to U.S. Patent Application No. 61/988,825, filed May 5, 2014; 61/988,894, filed May 5, 2014; and 62/056,260, filed Sep. 26, 2014.

### FIELD

The present invention generally relates to food processing and more particularly to systems, apparatus, and methods for managing food processing in food preparation establishments such as restaurants, including quick service restaurants.

### BACKGROUND

The success of restaurants depends in large part on speed of customer service and quality of food served to customers. In some restaurants, such as quick service restaurants, speed of service may be improved by forecasting or predicting food which will be ordered in the future and preparing food before it is ordered. For example, food may be prepared by cooking it (e.g., by baking, frying, grilling, etc.) and then holding it in a condition suitable for serving in anticipation of the food being ordered by a customer. It is desirable to monitor inventory of cooked food to ensure it is served to customers within a time period during which it is suitable for serving and discarded or wasted if the food has not been served before that time period expires. Some systems for food management for quick service restaurants are known.

### SUMMARY

One aspect of the present invention is directed to a food cooking system. The system includes a master control system including a processor, a tangible storage medium storing processor executable instructions, and a master control user interface. The master control user interface displays a variable cook list listing at least one food item type to be cooked. The variable cook list changes based on need for food. The variable cook list has a highest priority position for indicating a food item type of highest priority to be cooked. The system includes a cooking device operatively connected to the master control system. The cooking device is configured for cooking the at least one food item type. The cooking device includes a processor, a tangible storage medium storing processor executable instructions, and a user interface. The cooking device user interface displays the variable cook list listing the at least one food item type to be cooked. The cooking device user interface includes at least one cook recipe button for causing the cooking device to execute a cook recipe associated with the at least one food item type to cook the at least one food item type.

Another aspect of the present invention is directed to a food preparation control module. The module includes a master control system including a processor and a tangible storage medium having processor executable instructions. The master control system includes a first display for displaying information relating to food items to be cooked by cooking apparatus and to be held by food holding apparatus. The module includes a food preparation apparatus control system including a processor and a tangible storage medium having processor executable instructions. The food preparation apparatus control system includes a second display. The master control system and the food preparation apparatus control system communicate with each other such that at least some information displayed on the first display is displayed on the second display.

Another aspect of the present invention is directed to a cooked food transfer management control system for managing transfer of cooked food in a food preparation establishment. The cooked food transfer management control system optionally includes a food cooking device configured for cooking food. The system optionally includes a cooked food holding apparatus having at least one cooked food holding location for holding cooked food from the food cooking device. The at least one cooked food holding location includes a heat-generating device configured for holding the cooked food at a holding temperature at the at least one cooked food holding location. The system includes a cooked food transfer management controller configured for managing transfer of cooked food from the food cooking device to the cooked food holding apparatus. The system includes a tangible storage medium storing therein a predetermined threshold cooked food transfer time for transferring cooked food from the cooking device to the cooked food holding apparatus. The tangible storage medium has cooked food transfer management controller executable instructions stored therein. The instructions, when executed by the cooked food transfer management controller, determine an actual cooked food transfer time elapsed before the cooked food is held at the at least one cooked food holding location and determine a cooked food transfer delay as a function of the predetermined threshold cooked food transfer time and the actual cooked food transfer time.

Another aspect of the present invention is directed to a computer executable method for managing transfer of cooked food in a food preparation establishment. The method includes cooking food with a food cooking device. The method includes operating a cooked food transfer management controller to monitor actual cooked food transfer time elapsed before the cooked food is held at a cooked food holding location of a cooked food holding apparatus. The method includes determining, with the cooked food transfer management controller, a cooked food transfer delay as a function of a comparison of the actual cooked food transfer time and a predetermined threshold cooked food transfer time.

Another aspect of the present invention is directed to a cooked food transfer management control system for managing transfer of cooked food from a food cooking device to a food holding apparatus. The food holding apparatus has at least one cooked food holding location for holding cooked food from the food cooking device. The at least one cooked food holding location includes a heat-generating device configured for holding the cooked food at a holding temperature at the at least one cooked food holding location. The cooked food transfer management control system includes a cooked food transfer management controller configured for managing transfer of cooked food from the food cooking device to the cooked food holding apparatus. The cooked food transfer management control system includes a tangible storage medium storing therein a predetermined threshold cooked food transfer time for transferring cooked food from the cooking device to the cooked food holding apparatus. The tangible storage medium has cooked food transfer management controller executable instructions stored therein. The instructions, when executed by the cooked food transfer management controller, determine an actual cooked food transfer time elapsed before the cooked food is held at the at least one food holding location and determine a cooked food transfer delay as a function of the predetermined threshold cooked food transfer time and the actual cooked food transfer time.

Another aspect of the present invention is directed to a heat control for use with a food holding unit having at least one heating compartment for holding pre-cooked food previously cooked by a food cooking device. The food holding unit includes a heat source associated with the at least one heating compartment for holding the pre-cooked food at a selected temperature. The heat control includes a heat control processor for controlling operation of the heat source to deliver heat to the pre-cooked food in the heating compartment. The heat control includes heat control processor executable instructions for controlling the operation of the heat source according to a programmed holding cycle heating recipe to deliver heat to the pre-cooked food in the holding compartment for a holding cycle. The heat control includes heat control processor executable instructions for modifying the programmed holding cycle heating recipe as a function of a time between cooking of the food being complete and the food being placed in the food holding unit.

Yet another aspect of the present invention is directed to a food cooking system. The food cooking system includes a cooking device configured for cooking food. The food cooking system includes a cooking device control system associated with the cooking device. The cooking device control system includes a processor, a tangible storage medium storing processor executable instructions, and a user interface for receiving input from a user. The tangible storage medium stores food cook recipe instructions for a food item type. The instructions, when executed by the processor, operating the cooking device according to a cook recipe comprising a number of different cook cycle phases to cook the food item type in the cooking device. The user interface is configured for changing the cook recipe instructions for the food item type. For each cook cycle phase, at least one of a cook time, a cook temperature, and an on/off condition for one of more heat sources, is selectively modifiable via the user interface.

Other objects and features of the present invention will be in part apparent and in part pointed out herein.

### BRIEF DESCRIPTION OF THE DRAWINGS

FIG. 1 is a schematic of a food management system of the present invention;

FIG. 1A is a schematic representation of product holding apparatus of the present invention including multiple food holding units each having a plurality of food holding locations;

FIG. 2 is a schematic of a master control system;

FIG. 3 is a screenshot of a graphic user interface, the graphic interface displaying a cook list section on the left and a food holding apparatus status section on the right;

FIGS. 4-12 are screenshots of the graphic user interface including the food holding apparatus status indication section;

FIGS. 13-15 are schematic representations of a cook list;

FIG. 16 is a schematic of a control module including the master control system of FIG. 2 and a food preparation apparatus control system;

FIGS. 17-34 are screenshots of a graphic user interface of the control module;

FIG. 35 is a schematic of a food transfer management system; and

FIGS. 36-40 are screenshots of a graphic user interface of the food transfer management system.

Corresponding reference characters indicate corresponding parts throughout the drawings.

### DETAILED DESCRIPTION

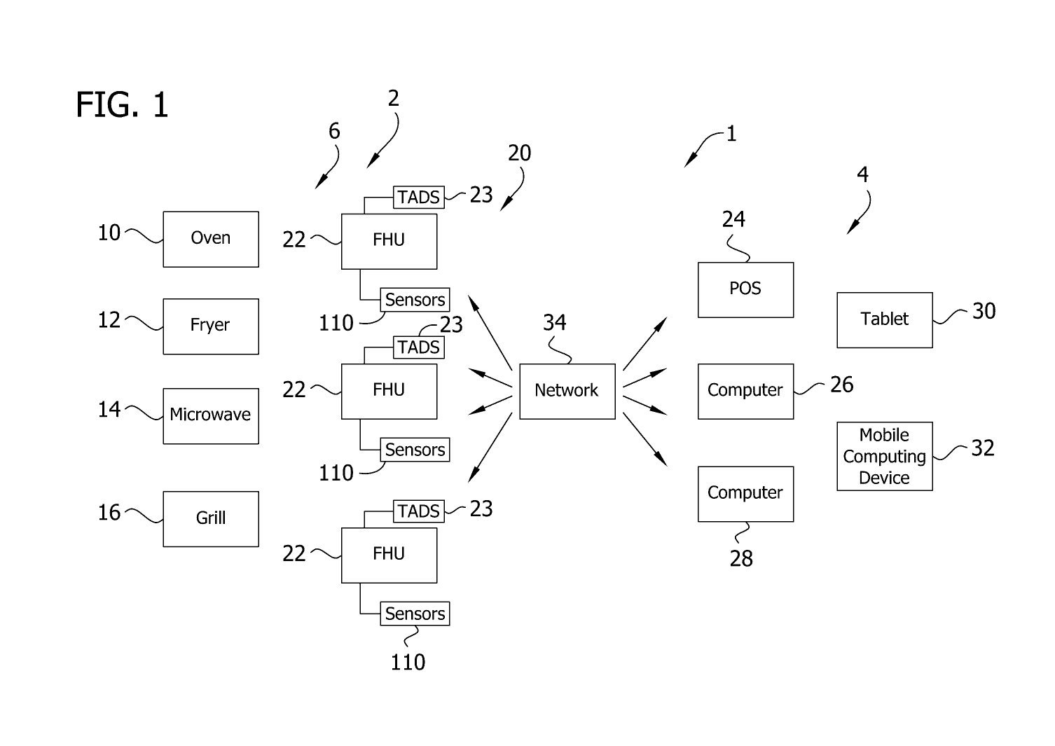

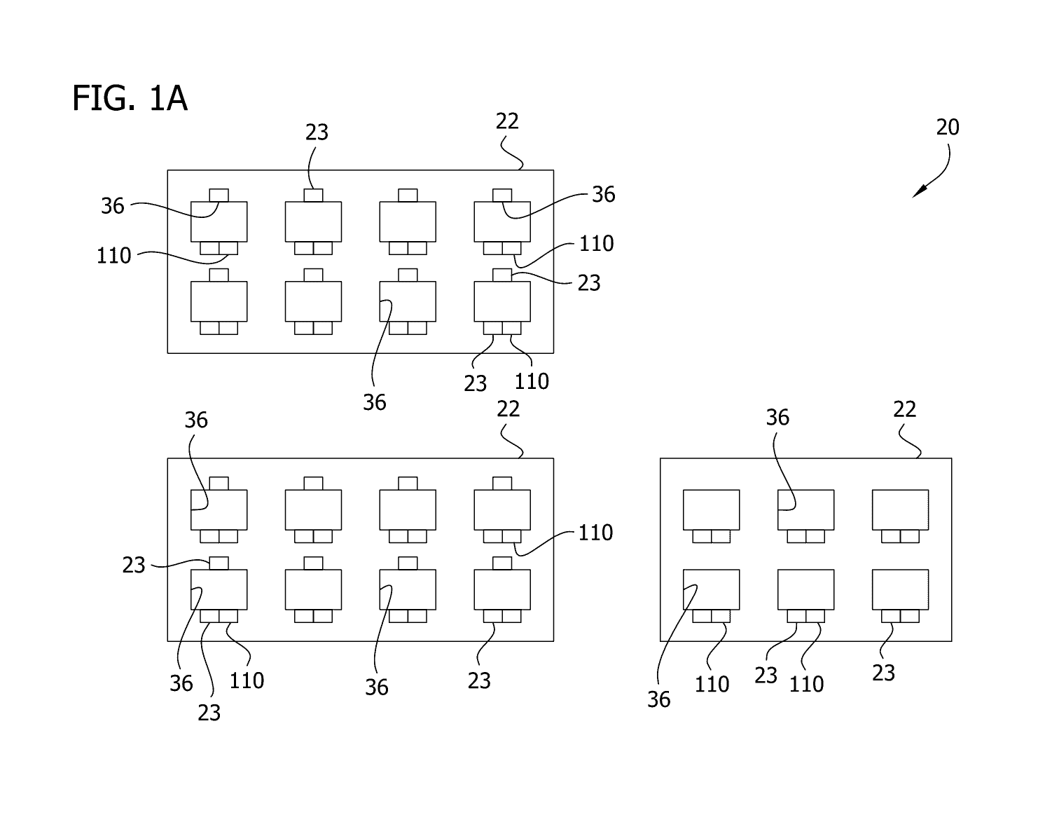

Referring to the drawings, FIG. 1 illustrates one embodiment of a food management system according to the present invention, indicated generally by the reference number 1. The system 1 may be used in various types of food preparation establishments, such as restaurants, including quick service or “fast food” restaurants. The system 1 can be used for forecasting or predicting food that will be ordered in the future, preparing food, monitoring food preparation and food inventory, providing indications and instructions regarding food preparation and food inventory, and so forth. The system 1 may include food preparation apparatus 2 and control apparatus 4. The food preparation apparatus 2 may include various food cooking devices 6 such as ovens 10, fryers 12, microwaves 14, and grills 16. The food preparation apparatus 2 may also include food holding apparatus 20 such as one or more food holding units 22 for holding cooked food in a condition suitable for serving. The control apparatus 4 may include various devices such as point-of-sale devices 24, local computers 26, remote computers 28, tablets 30, hand-held computing devices 32 (e.g., smart telephone), etc. The control apparatus 4 may be operatively connected with each other via a wired and/or wireless network 34 or other means. The control apparatus 4 may also be operatively connected with the food preparation apparatus 2 for sending and/or receiving signals therefrom.

An aspect of the present invention relates to the food holding apparatus 20. In one example, as shown in FIG. 1A, the food holding apparatus 20 may include one or more food holding units 22 adapted for holding food at a suitable temperature (e.g., cool temperature, ambient temperature, and/or warm temperature). Such food holding units 22 may include one or more locations 36 (e.g., compartments or wells) in which food may be received and held (e.g., in a container such as a pan). The holding locations may include one or more temperature altering devices 23 (for heating and/or cooling), including components such as a heat sink, infrared emitter, condenser, etc. For example, the food holding units 22 may include holding locations 36 with heat generating devices 23 adapted for holding cooked food in a warm condition suitable for serving. Examples of food holding units of this type are disclosed in U.S. Pat. Nos. 6,541,739, 7,105,779, and 7,328,654, all of which are hereby incorporated by reference in their entireties. In another example, the holding apparatus 20 may include holding units 22 in the form of tables, countertops, shelves, cabinets, housings, refrigerators, freezers, other support structures or surfaces, or any combination thereof suitable for supporting food at holding locations. The holding locations may not include particular structure forming a compartment or well. For example, two holding locations may be adjacent portions of a generally flat support surface. The holding locations may be configured for holding the food in a warmed, refrigerated, ambient, or other environment. Depending on the needs of a particular quick service restaurant, one or more holding units 22 may be used. It will be understood that food held at holding locations of the food holding apparatus 20 may be held in a container, such as a pan, bag, box, or package, or may be placed uncontained or unpackaged at the holding location.

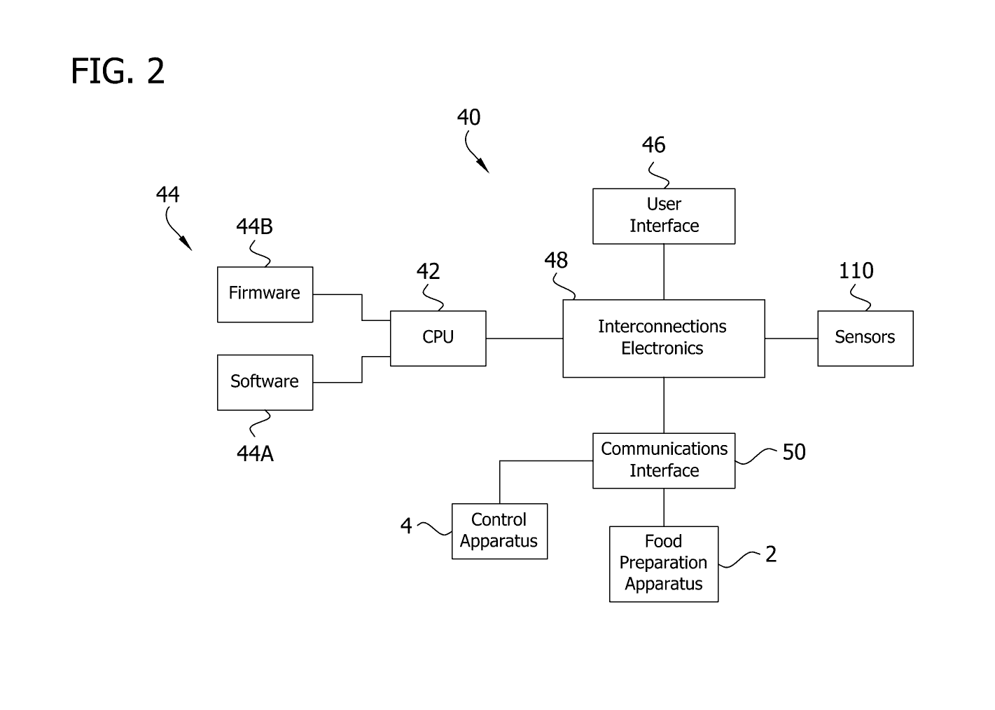

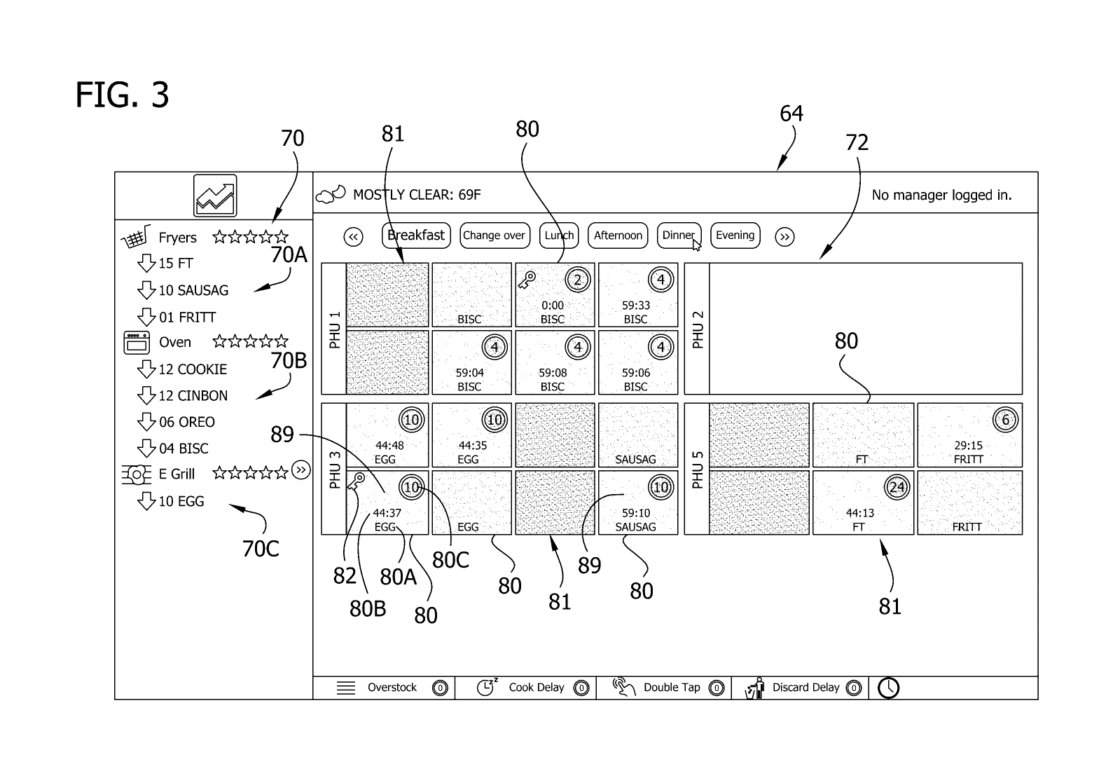

A master control system 40 associated with the product holding apparatus 20 is shown schematically in FIG. 2. Components of the control system 40 may be part of the holding apparatus 20 and/or other apparatus of the system 1, such as the point-of-sale device 24, local computer 26, remote computer 28, tablet 30, hand-held mobile computer 32, etc. The master control system 40 includes a controller 42 (e.g., central processing unit or “CPU” or broadly “food management controller”) including one or more processors, a tangible storage medium 44 (e.g., including forms of storage such as software 44A and firmware 44B), and a user interface 46. The tangible storage medium 44 may include at least one memory device, and information may be stored in the tangible storage medium (e.g., on at least one memory device) in one or more modifiable data structures. The controller 42 may be a microprocessor or the like. The master control system 40 includes interconnection electronics 48 that operatively connect the various components of the control system 40 and may connect the control system via a communications interface 50 with other control apparatus 4 and/or food preparation apparatus 2. For example, the interconnection electronics 48 may include electrical or fiber optic lines or wireless communication devices. The communications interface 48 may include wired or wireless communications devices or connectors (e.g., USB flash drive port, other types of data ports, modems, wireless signal transmitters/receivers, etc.). The controller 42 is adapted for reading and executing processor executable instructions stored in the storage medium 44, and the controller is responsive to the user interface 46, such as for controlling various components and systems of the control system 40. A user can enter or modify instructions stored on the storage medium 44 via the user interface 46 and/or via a communications interface 50. In the illustrated embodiment, the user interface 46 includes a touch screen display 64 (e.g., see FIG. 3), as explained in further detail below. The touch screen display 64 includes a screen for displaying various views to the employees and is sensitive to the touch of the employees for receiving input signals from the employees by user engagements with the touch screen (e.g., via finger “taps,” “swipes,” or “sustained presses”). Alternatively or in addition, the user interface 46 may include a display not sensitive to touch of a user. The user interface 46 may also include other input/output devices such as a keyboard and/or various types of audio/visual devices, such as a timer bar including buttons on the food holding apparatus. Other types of user interfaces may be used without departing from the present invention. The user interface 46 provides command signals via the interconnection electronics 48 to the controller 42. The command signals can include changes to the parameters (e.g., food preparation or inventory parameters, etc.) stored in the tangible storage medium 44. The controller 42 responds to the command signals and provides information (e.g., food status indications) and/or instructions via the interconnection electronics 48 to the user interface 46 to be communicated to the employees.

The at least one touch screen display 64 is associated with the food holding apparatus 20 for monitoring food preparation and inventory (e.g., uncooked and/or cooked food inventory) and providing associated information and instructions to employees. For example, the touch screen display 64 may be part of the point-of-sale device 24, local computer 26, remote computer 28, tablet 30, and/or hand-held computing devices 32, etc. At least one touch screen display 64 is desirably positioned proximate the food holding apparatus 20 for reference by employees using the food holding apparatus. For example, in one embodiment, the touch screen display 64 is part of the tablet 30 and is mounted or otherwise supported next to the food holding apparatus 20. Alternatively, the touch screen display 64 may be part of the food holding apparatus 20. For example, the food holding unit 22 may include multiple touch screen displays (e.g., arranged in an array on the holding unit) associated with and positioned proximate to respective individual or groups of holding locations 36, or the food holding unit 22 may include a global touch screen display associated with all of the holding locations.

The user interface 46 (e.g., the touch screen display 64) may provide information to the employees and receive information from the employees regarding many aspects of food preparation and inventory, some of which will be understood by reference to the patents incorporated by reference herein. The touch screen display 64 may indicate to employees amounts and types of food to be cooked based on forecasted and/or recent orders. In addition, the touch screen display 64 may indicate to employees status of food being held in the food holding apparatus 20 (e.g., whether the food is suitable for being served, whether its hold time has expired, etc.).

FIG. 3 shows a screen shot of an example view (graphic interface) that may be displayed on the touch screen display 64. The view includes on the left side a cook list section 70 indicating food to be cooked, and on the right side a food holding apparatus status indication section 72 showing status of the holding locations 36 of the holding apparatus 20 where food may be held. Regarding the cook list section 70, it will be understood that the control system 40 may forecast or predict food expected to be ordered in predetermined time increments (e.g., in time increments of 10, 15, 20, 30, 45, or 60 minutes), and the food needed to be cooked (demand) to meet upcoming time increments may be shown on the cook list section. Various calculations or algorithms may be used to predict the food needed to meet future orders. The forecasting may be based on historical data (e.g., sales in dollars and/or food amounts) generated by the point-of-sale device 24, recent trends in sales or demand for food types (e.g., as determined by signals from the point-of-sale device, such as recent customer orders), and other parameters or special factors (e.g., weather, local sporting events). In the illustrated embodiment, the cook list section 70 includes a plurality of cook lists 70A, 70B, 70C corresponding to different cooking devices including the fryers 12, ovens 10, and grills 16. It will be understood that other types of food preparation apparatus (such as the microwave 14, etc.) may be shown based on the apparatus needed for preparing food at the relevant time of the day. Moreover, one cook list may include food types to be cooked by different cooking devices without departing from the scope of the present invention. The food types to be cooked are indicated by a food type indicator such as a full or abbreviated name of the type of food (e.g., “BISC” for biscuits, “FT” for French toast, “EGG” for eggs, and so forth) and an amount of that food type to be cooked (e.g., “15” for “FT,” “10” for “SAUSAG”), which together may be referred to as a line item. The food type indicator may include a symbol (e.g., graphic) in place of or in addition to the alpha/numeric text for the food type indicator and/or amount to be cooked. The cook lists are stored on the tangible storage medium 44 (e.g., in a data structure therein) and are modifiable by the controller 42, as will become apparent. Additional aspects of the food cook list section 70 will be described in further detail below.

Food may be stored in the food holding apparatus 20 (e.g., after it is cooked or otherwise prepared, such as by thawing, cutting, assembling, and/or portioning) until it is served to a customer or discarded as waste. Inventory of food held in the food holding apparatus 20 may be monitored by the master control system 40, and indications of the status of the holding locations 36 (e.g., status of food held at the holding locations) may be shown on the touch screen display 64. As will be explained in further detail, the food holding apparatus status section 72 indicates status of food holding locations 36 such as “no food present,” “food present,” “food suitable for serving,” “food to be served first,” “food to be served second,” and “food expired or to be discarded.”

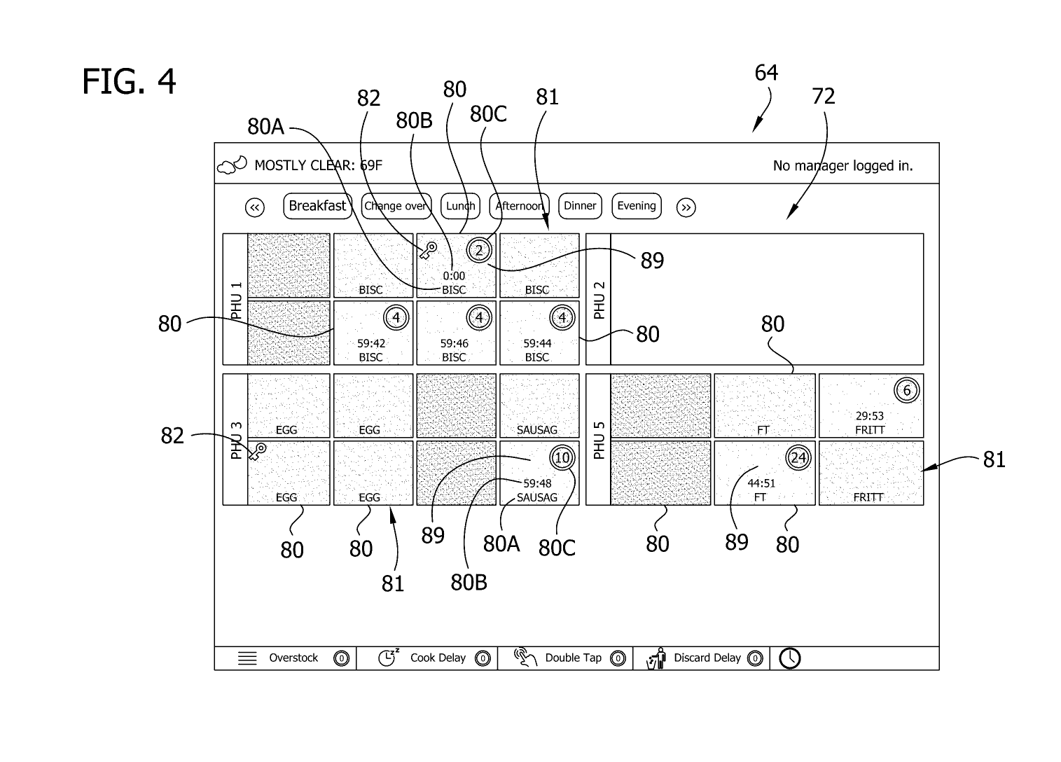

Referring to FIG. 4, in which a partial view of the touch screen display 64 is shown without the cook list section 70, the food holding apparatus status section 72 includes an array of holding location displays 80 representing respective holding locations 36 of the food holding apparatus 20 and on which information associated with the respective holding locations is displayed. The holding location displays 80 are arranged in an array (e.g., including columns and rows) corresponding to an arrangement of the food holding locations 36, and the holding location displays are positioned in the array corresponding to the position of the respective holding locations in the arrangement. The array of compartment displays 80 includes sub-arrays 81 of holding location displays representative of holding locations 36 of individual food holding units 22 (e.g., “PHU 1,” “PHU 2,” “PHU 3”). The status of the respective locations 36 may be shown by status indicators such as symbols, color, outlining, bolding, flashing, text, numbers, graphics or other visual indicators. In the illustrated embodiment, the locations 36 that are inactive are indicated by a generally blank holding location display 80 and dim or gray appearance of the holding location display. The holding locations 36 that are active are indicated at least by a food type indicator 80A (e.g., food type name or symbol, etc. representing the food type) indicating the food type to be held at the holding location. Among the active holding locations 36, those in which no food is held are indicated by there not being a countdown timer 80B displayed and optionally a relatively dim appearance or blue shading of the holding location display 80. The holding locations 36 in which food is held are indicated by a lighter (e.g., illuminated/white) appearance, a displayed hold time indicator 80B (e.g., countdown timer), and a food amount indicator 80C (e.g., a number representative of the amount of food held at the location 36). A holding location 36 having food for which the hold time has not yet elapsed and which has been held the longest (or will expire the soonest) among locations holding the same type of food is indicated by green coloring. For example, the hold time indicator 80B, food type indicator 80A, and food amount indicator 80C may be displayed in green. Alternatively, the holding location display 80 may include a green background. Holding locations 36 having the same food type that have been held for a shorter time are indicated by yellow coloring (or orange/amber coloring). For example, the hold time indicator 80B, food type indicator 80A, and food amount indicator 80C may be displayed in yellow. Alternatively, the holding location display may include a yellow background. It will be understood that these indicators convey to the employees to serve food from the location 36 indicated by green (corresponding to food longest held or soonest to expire) before serving food from the location indicated by yellow to facilitate a “first-in, first-out” serving convention. A holding location 36 having food for which the hold time has elapsed is indicated by red coloring. For example, the hold time indicator 80B (e.g., “0:00”), food type indicator 80A, and food amount indicator 80C may be displayed in red. Alternatively, the holding location display 80 may include a red background (e.g., flashing red background). The processor 42 is responsive to instructions in the tangible storage medium 44 and user input from the user interface 46 for displaying, updating, and changing the indicators on the holding location displays 80.

Although the holding location displays 80 are illustrated as all being sections of the touch screen display 64, it will be appreciated that other configurations can be used without departing from the scope of the present invention. For example, the holding location displays 80 could be unconnected or separate from each other (e.g., on respective separate touch screen displays). Such separate holding location displays could still be arranged in an array corresponding to the holding locations. For example, the holding location displays 80 could be positioned on the holding apparatus 20 in such an array (e.g., next to the respective holding locations 36).

Although the illustrated hold time indicators 80B are count down timers, it will be understood other hold time indicators may be used without departing from the scope of the present invention. For example, the hold time indicator may be a count up timer, a static time (e.g., static expiration time), color, symbol, graphic, text, bolding, highlighting, outlining, or other indicator without departing from the scope of the present invention. As used herein, the term “hold time” can mean an expiration time, a time remaining until expiration, a time food has been held, etc., without departing from the scope of the present invention.

Although the illustrated food amount indicators 80C indicate numbers of food items, it will be understood other types of food amount indicators may be used without departing from the scope of the present invention. For example, it may be desirable to indicate amount of food by weight, volume, percentage (e.g., percentage of an amount), or other measures, any of which may be used without departing from the scope of the present invention.

In one aspect of the present invention, employees may be trained to serve food from designated “primary” or “serving” locations 36 of the holding apparatus 20. It may be desirable to train the employees to serve from these designated primary locations 36 for ease of use and efficiency. For example, when the primary holding location is not holding food, employees should transfer non-expired food of that type held in other locations 36 to the primary location for that food type, or place new food at the primary location instead of a different location for that food type. The primary locations 36 may be indicated by primary location indicators 82 on the respective holding location displays for distinguishing the primary locations from other locations designated for holding the same type of food. In the illustrated embodiment, primary locations 36 are indicated by “key” symbols 82 in the upper left corner of the holding location displays 80 representative of the primary locations. The primary holding location indicators 82 are particularly helpful to a user in distinguishing the primary holding location from another holding location when both holding locations are indicated on the respective holding location displays as being active but not holding food. For example, referring to FIG. 4, the two lower “EGG” holding locations are both shown by their holding location displays 80 as being active but not holding food. The holding location displays for those two holding locations have essentially the same appearance except for the primary holding location indicator 82 distinguishing one from the other. To assist a user in placing food at the primary holding location, if the user attempts to enter food at a non-primary holding location (e.g., via user input), and the primary location is not holding food, the controller 42 may prompt the user (e.g., with an appropriate alert or prompt window) to enter the food into the primary holding location instead of the non-primary holding location. The primary locations 36 may be indicated in other ways, such as by other symbols (e.g., stars, asterisks, etc.), graphics, text, color, outlining, bolding, highlighting, etc. without departing from the scope of the present invention. For example, the primary locations 36 may be lower, left locations relative to the other locations (e.g., at a bottom left side of the array of holding location displays) for holding the same type of food (e.g., see the EGG location displays 80 in FIG. 4), or may be a top, center location relative to the other locations (e.g., see the BISC location displays 80 in FIG. 4). The primary location 36 may be pre-determined and stored in the tangible storage medium 44 (e.g., in a data structure stored by the tangible storage medium). The primary locations 36 may be programmed and re-programmed (e.g., using the user interface 46) according to preference and convenience. The primary locations will be discussed in further detail below with respect to transfer of food among holding locations.

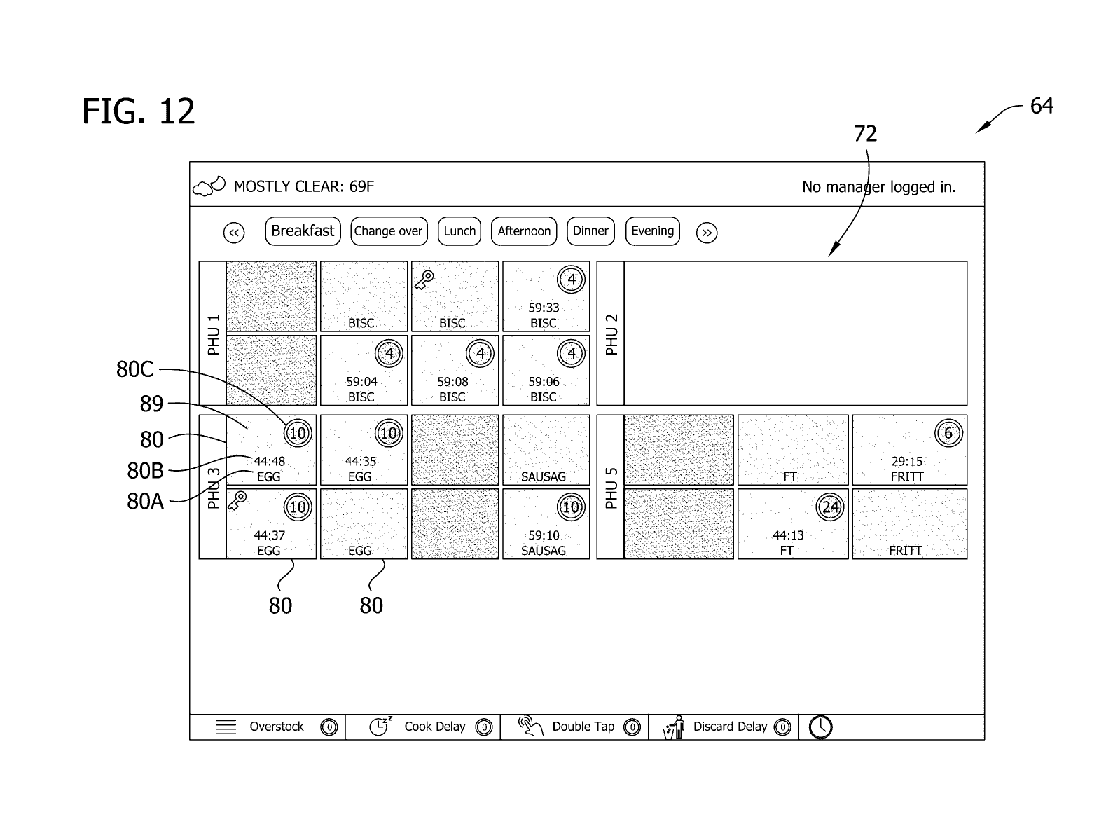

Various aspects and functions of the master control system 40 and in particular the user interface 46 (e.g., touch screen display 64) will now be explained with reference to FIGS. 4-12. In an aspect of the present invention, various operations of the control system 40 may be initiated or executed by different user engagements with the touch screen display 64, and in particular with buttons 89 of the holding location displays 80. For example, an employee may perform different engagements by “quickly tapping” (e.g., briefly touching for 0.5 seconds or less and releasing) or “long holding” (i.e., “sustained pressing,” e.g., for 1 or 1.5 seconds) on the touch screen 64, as will be described in further detail below. As used herein, a “sustained press” is defined as being a substantially longer engagement than a “tap,” such as at least about 0.5 seconds, at least about 1 second, at least about 1.5 seconds, etc. longer than a tap. Other types of single user engagements may be used, such as “sustained pressing and dragging,” and multiple user engagements can be used, such as multiple “taps,” multiple “sustained presses,” and any combination of such user engagements, without departing from the scope of the present invention. The tangible storage medium 44 may include processor executable instructions for changing the result brought about by or the operation executed as a result of the different types of engagements of the touch screen display 64 as a function of the status of the particular holding location 36 indicated by the holding location display 80 engaged by the employee. It will be appreciated that the multiple functionality of the holding location display buttons 89, and the changing functionality of the buttons as a function of the status of the holding locations 36 (as indicated by the holding location displays 80), may enable the food holding apparatus status section 72 to have a relatively clean appearance and be relatively uncluttered, which enhances user understanding and facilitates efficient interaction.

In the illustrated embodiment, the food holding apparatus status section 72 includes the plurality of holding location displays 80, which each include a touch sensitive area defining the button 89. In the illustrated embodiment, the buttons 89 are substantially co-extensive with the holding location displays 80 and have respective boundaries adjacent boundaries of the holding location displays. In the illustrated embodiment, the boundaries of the buttons 89 are shown as rectangular outlines or borders that are also the boundaries of the respective holding location displays 80. The buttons 89 may have other sizes and shapes without departing from the scope of the present invention. For example, the buttons may be at least 40%, at least 50%, at least 60%, at least 70%, at least 80%, at least 90% or more of the holding location displays. The buttons 89 desirably have sufficient size to facilitate convenient engagement with them by a finger of a user. It will be appreciated that the holding location displays 80 may be relatively small, and it may be desirable to provide the buttons 89 with the largest size possible to facilitate engagement with the buttons. In the illustrated embodiment, the buttons 89 are the only buttons in the touch sensitive area of respective holding location displays 80. The size of the buttons 89 may be described with reference to the holding location indicators that are displayed on the holding location display 80 in the touch sensitive area defining the buttons. For example, one or more indicators such as the food amount indicator 80C, food hold time indicator 80B, and food type indicator 80A can be displayed in the touch sensitive area of the holding location display 80 defining the button 89. In the illustrated embodiment, when the holding location display indicates no food is held and when it indicates food is held and not yet expired, only information representative of the status of the holding location is displayed in the touch sensitive area of the holding location display 80 defining the button 89. When a holding location display indicates a status of no food held or food held is not yet expired, the touch sensitive area of the holding location display is free of any indicator indicating an operation executed in response to engagement with the button. It is believed the above features provide the holding location displays with a relatively clean appearance and facilitate quick user comprehension and interaction. Other button configurations may be used without departing from the scope of the present invention. As will be described in further detail below, the buttons 89 may be actuated by different types of user engagement with the buttons, such as the user engagements described above. For example, a button 89 may be actuated by briefly tapping the button to bring up a prompt window providing access to various other buttons associated with the holding location 36 or by making a sustained press of the button to execute certain functions with or without bringing up a prompt window. It will be understood that the operations initiated or executed by the different types of user engagement with the buttons 89 associated with the holding locations 36 (e.g., brief tap and sustained press) may be other than described or be switched without departing from the scope of the present invention.

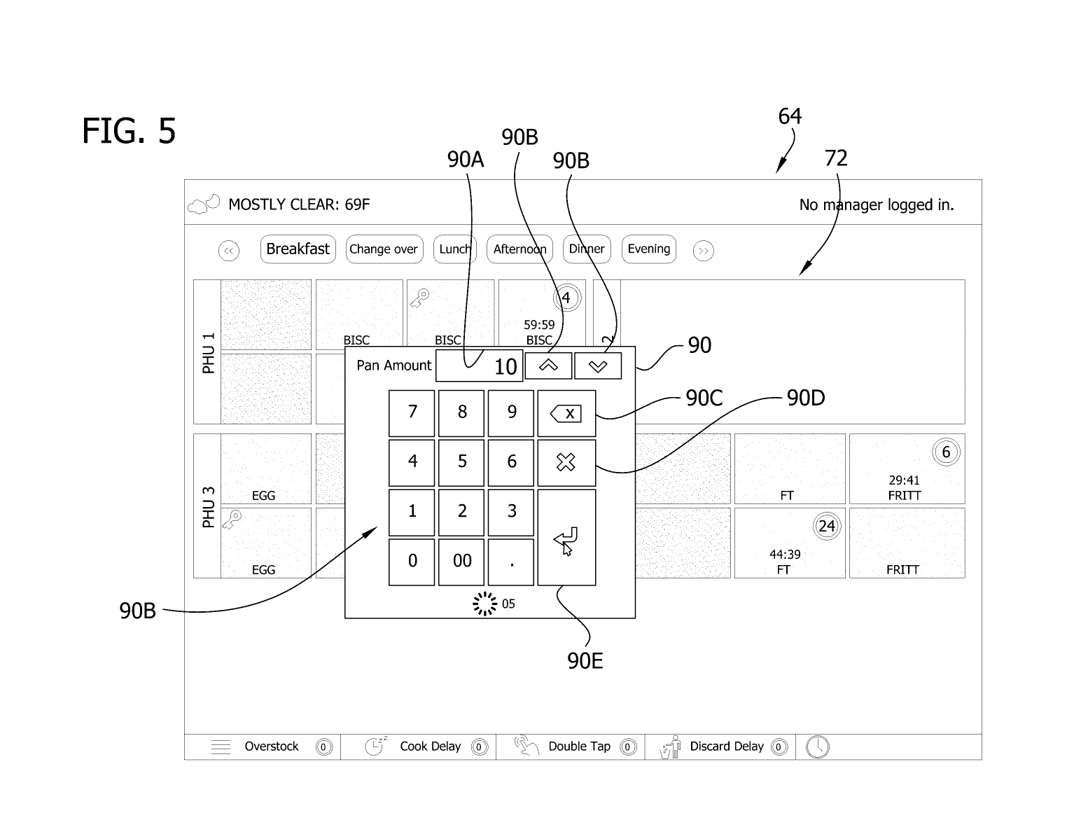

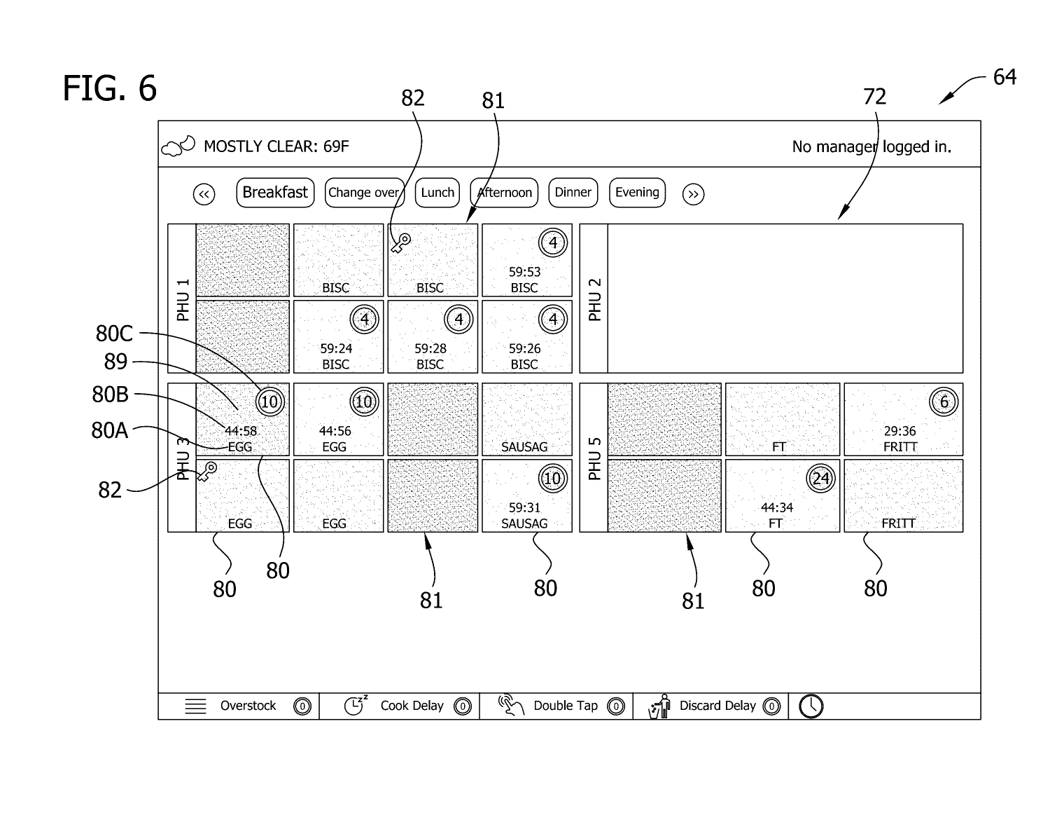

When food is ready to be held in the food holding apparatus 20 (e.g., after the food has been cooked), an employee may place the food at a chosen location 36 of the food holding apparatus appropriate for holding the particular type of food. Desirably, the chosen location 36 is indicated on its holding location display 80 as being active but not holding food. For example, as shown in FIG. 4, if the employee cooked eggs, the employee may place them in the top right EGG location 36. To signal to the master control system 40 that the eggs are now present in that location 36, the employee may briefly “tap” or “long hold” (“sustained press”) the holding location display 80 representing that location on the touch screen display 64. If the employee “taps” the holding location display 80, the prompt window 90 shown in FIG. 5 appears. The prompt window 90 includes an input value field 90A, number buttons 90B, a back or delete button 90C, a discard or waste button 90D, and an enter or return button 90E. The input value field 90A may be automatically filled with the amount of that type of food the control system expects that the employee cooked. In other words, the amount of eggs that the cook list 70C instructed the employee to cook (in this case 10) may be automatically provided by the controller 42 in the input value field 90A as a default or suggested amount of food to be entered. If the employee would like to deviate from the suggested amount of food (e.g., if a different amount was cooked), they may change the amount in the input value field 90A using the delete button 90C and number buttons 90B. The employee may press the enter button 90E to signal to the control system 40 that the amount shown in the input value field 90A is the amount of food supplied to the relevant holding location 36. The controller 42 logs this amount in the tangible storage medium 44 as being the amount of food held at the associated holding location 36. The prompt window 90 then closes, and the food amount indicator 80C and hold time indicator 80B appear on the holding location display 80 representative of that location 36. If the employee does not press the enter button 90E, the prompt window 90 will disappear after a predetermined relatively short time (e.g., 2, 3, 4, etc. seconds), and the food amount shown in the input value field 90 will be entered and appear in the food amount indicator 80C on the holding location display 80, such as shown in FIG. 6. Alternatively, if the employee would like to bypass the prompt window 90, the employee may “long hold” the holding location display 80 associated with the holding location 36, which will cause the suggested or default amount of food to be entered (e.g., without any further user input from the employee). The controller 42 logs this amount in the tangible storage medium 44 as being the amount of food held at the associated holding location 36. The prompt window 90 will not be shown, the default food amount will be represented by the food amount indicator 80C, and the countdown timer 80B will appear and begin to count down.

While a holding location 36 is indicated on its respective holding location display 80 as containing food, the amount of food indicated as being held at the holding location may be updated. For example, if the holding location 36 is indicated as “serve first” (e.g., green color), the master control system 40 will presume the employees are serving food from that location, and the controller 42 will change (e.g., update) the food amount indicator 80C of the holding location display 80 representing that “serve first” holding location 36 to represent a decreased amount of food, responsive to a signal from the point-of-sale device 24 indicating an amount of food of that type has been ordered by a customer. The controller 42 logs this decreased amount in the tangible storage medium 44 as being the amount of food held at the associated holding location 36. For example, if the food amount indicator 80C shows “10” and the point-of-sale device 24 signals a customer ordered one item of that food type, the controller 42 will display on the respective holding location display 80 an updated food amount indicator to show “9.” This may occur substantially in real-time, in a delayed fashion, and/or periodically. Moreover, for various reasons, the employees may need to update the amount of food indicated as being held. For example, some of the food may have fallen out of the pan while the employee was taking food from the pan. To manually increase or decrease the amount of food indicated by the food amount indicator 80C, the employee may briefly “tap” the holding location display 80 associated with the relevant location 36 to bring up the prompt screen 90 shown in FIG. 5. The employee may enter the correct amount of food in the input value field 90A such as by using the delete button 90C and/or the number buttons 90B and update the food amount indicator 80C with that amount using the enter button 90E. The controller 42 logs this amount in the tangible storage medium 44 as being the amount of food held at the associated holding location 36.

While a food holding location 36 is indicated on the associated holding location display 80 as containing food suitable for serving, the food may be transferred from that holding location to a different holding location, and the hold time indicator 80B may be transferred to the holding location display 80 associated with the different holding location. For ease of reference, the holding location 36 from which the food is transferred will be referred to as the origin holding location, and the location to which the food is to be transferred will be referred to as the destination holding location. For example, as explained above, it may be desirable for employees to serve food from a primary or serving location of the holding apparatus 20 for a particular type of food. If the primary holding location needs to be supplied with food, food from another holding location 36 (e.g., a container having an amount of food in it) may be transferred to the primary location. The identity of the primary holding location may be stored in the tangible storage medium 44 as a default destination holding location. In other words, transfers to the primary holding location may be executed automatically as “default transfers.” In such cases, the primary holding location indicator 82 can be referred to as a default destination location indicator. Alternatively or in addition, the master control system 40 may permit “selected transfers” (e.g., override of “default transfers”) in which the employee selects a desired destination holding location that is different than the default destination holding location. For example, processor executable override instructions responsive to user input would designate a different holding location 36 than the default location as the destination holding location. In one example, the instructions to identify the destination holding location would identify the default holding location as the only destination holding location unless the override instructions have been executed prior to execution of the identifying instructions.

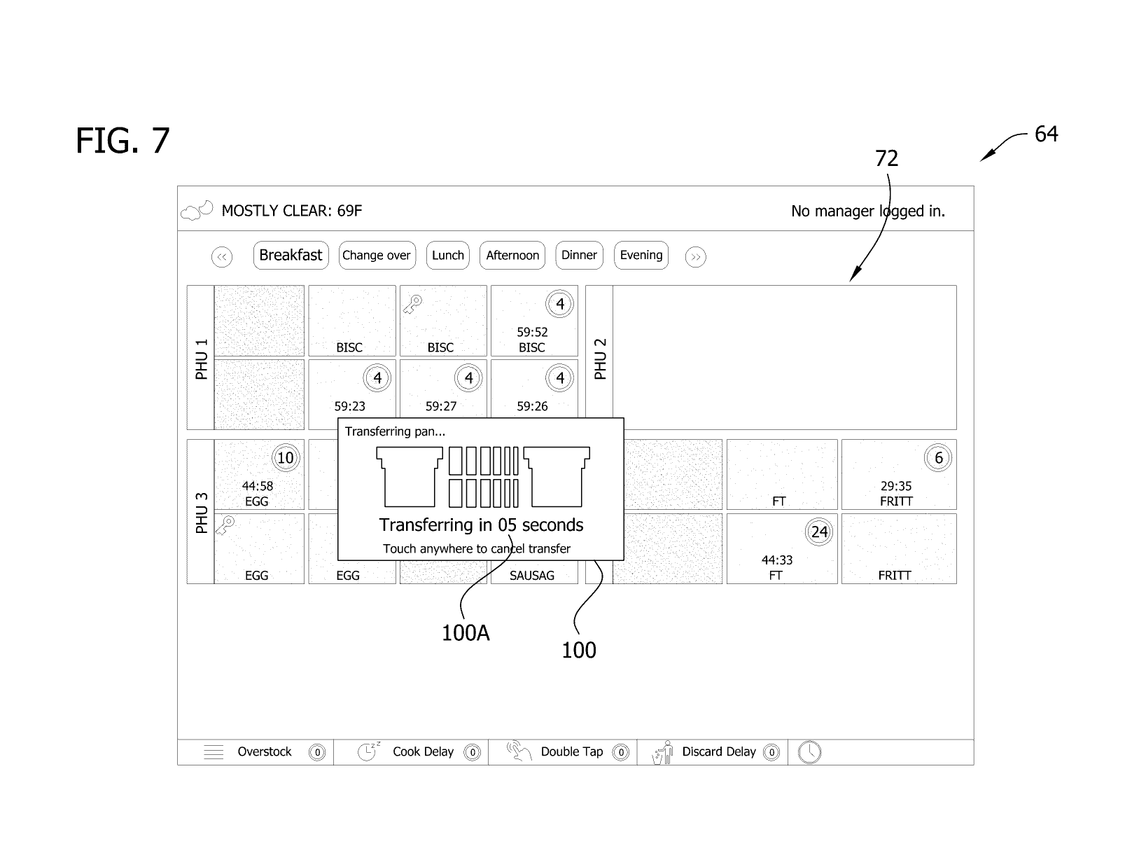

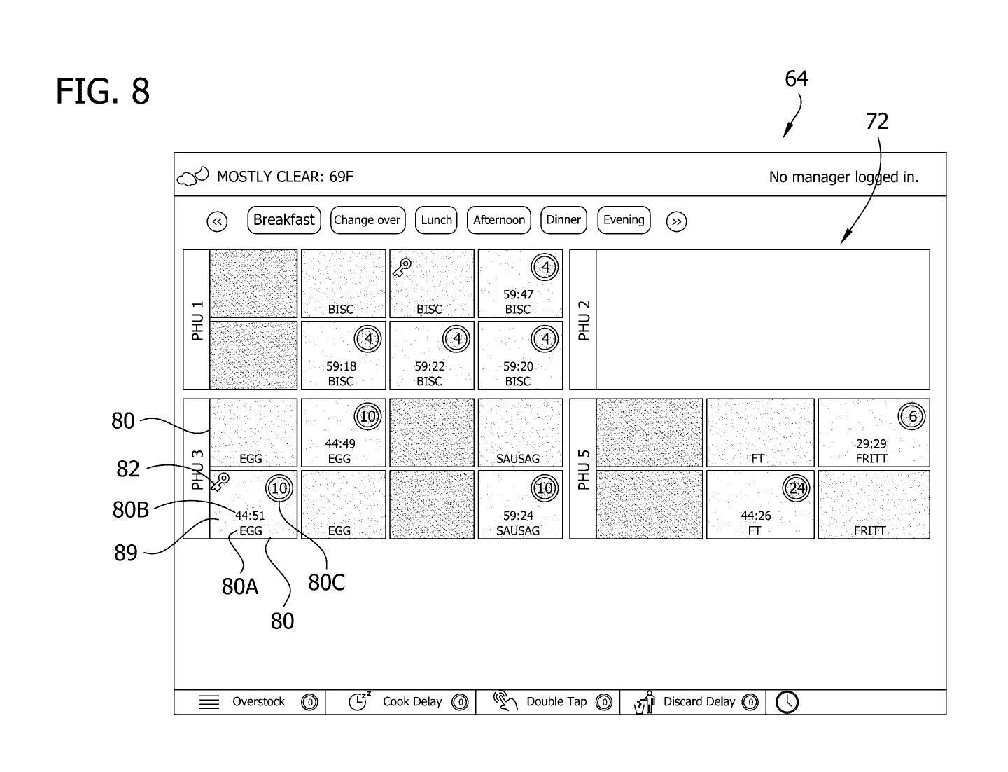

Transfers may be executed in various ways, such as by different types of user engagement with the buttons 89 of the holding location displays 80. For example, the transfer function may be executed by “long holding” (“sustained pressing”) the button 89 on the holding location display 80 for an origin holding location. Referring to FIG. 6, the top left EGG holding location 36 is indicated as being long held by the gray shading of the holding location display 80. The long hold may bring up a pending transfer window 100, such as shown in FIG. 7. The pending transfer window 100 may be shown for a relatively short pending transfer time (e.g., 2, 3, 4, 5, etc. seconds), during which time a pending transfer countdown timer 100A may be shown in the transfer window, and during which time the employee may cancel the transfer (e.g., by tapping the touch screen display 64 outside the transfer window 100). At the end of the pending transfer time, the transfer window 100 disappears, and the food amount indicator 80C and hold time indicator 80B are transferred from the origin holding location display 80 to the primary (destination) holding location display. The controller 42 transfers association of the hold time to the destination holding location and records this in the tangible storage medium 44. In other words, in response to the long hold, the control system 40 executes an “automatic transfer” to the default (primary) destination holding location display 80 (e.g., without any additional user input). For example, as shown in FIG. 8, the food amount indicator 80C and hold time indicator 80B have been transferred from the top left EGG holding location display 80 to the primary, bottom left EGG holding location display 80. The pending transfer window 100 may be omitted without departing from the scope of the present invention. In other words, a transfer may happen without the intermediate step of displaying the transfer window 100.

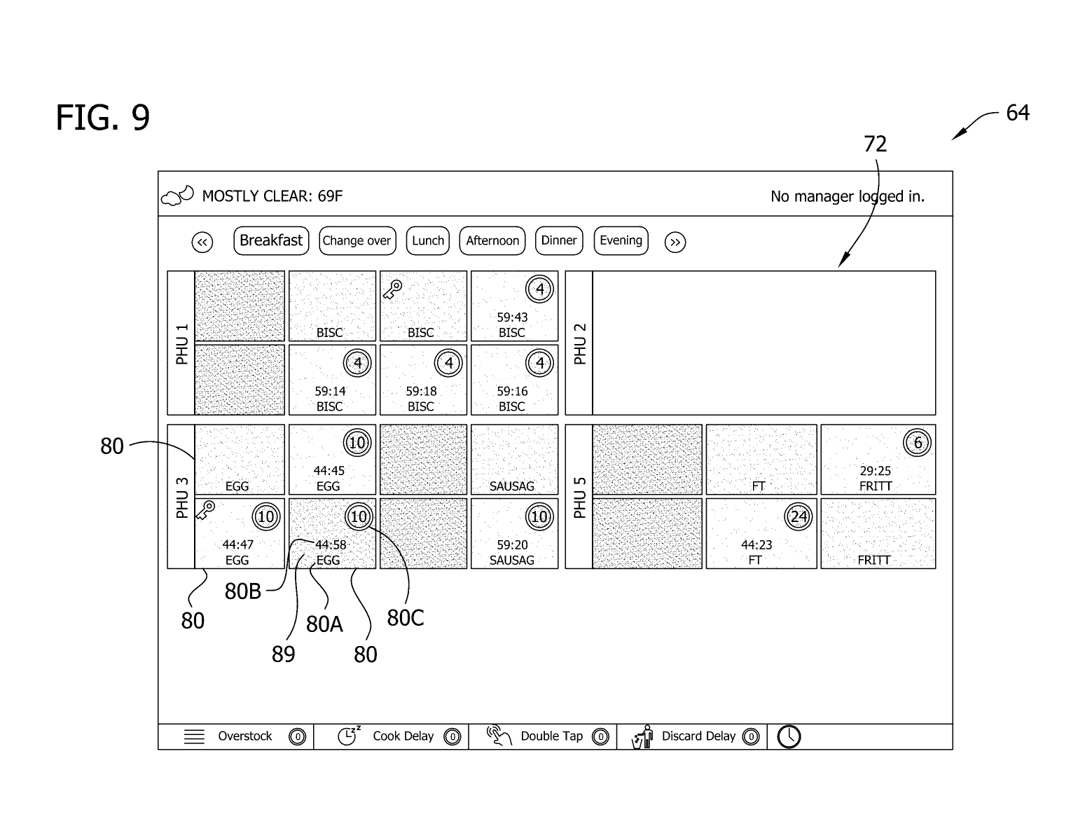

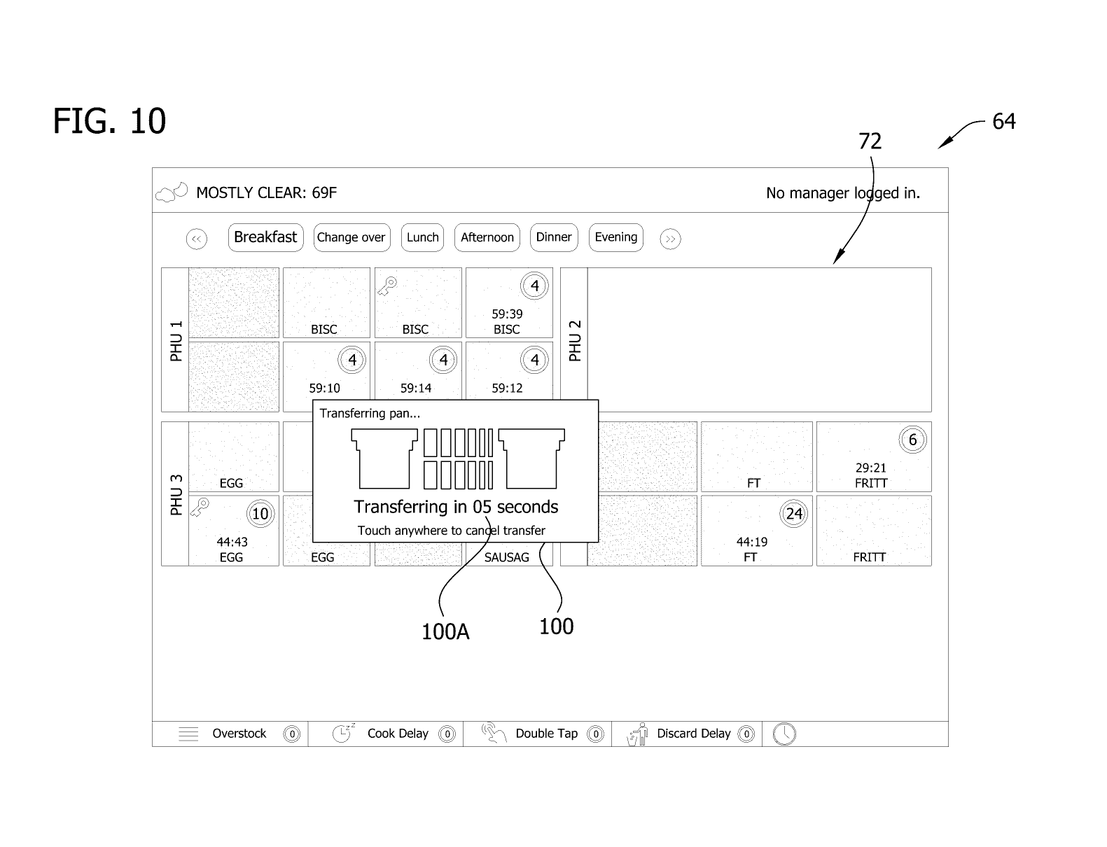

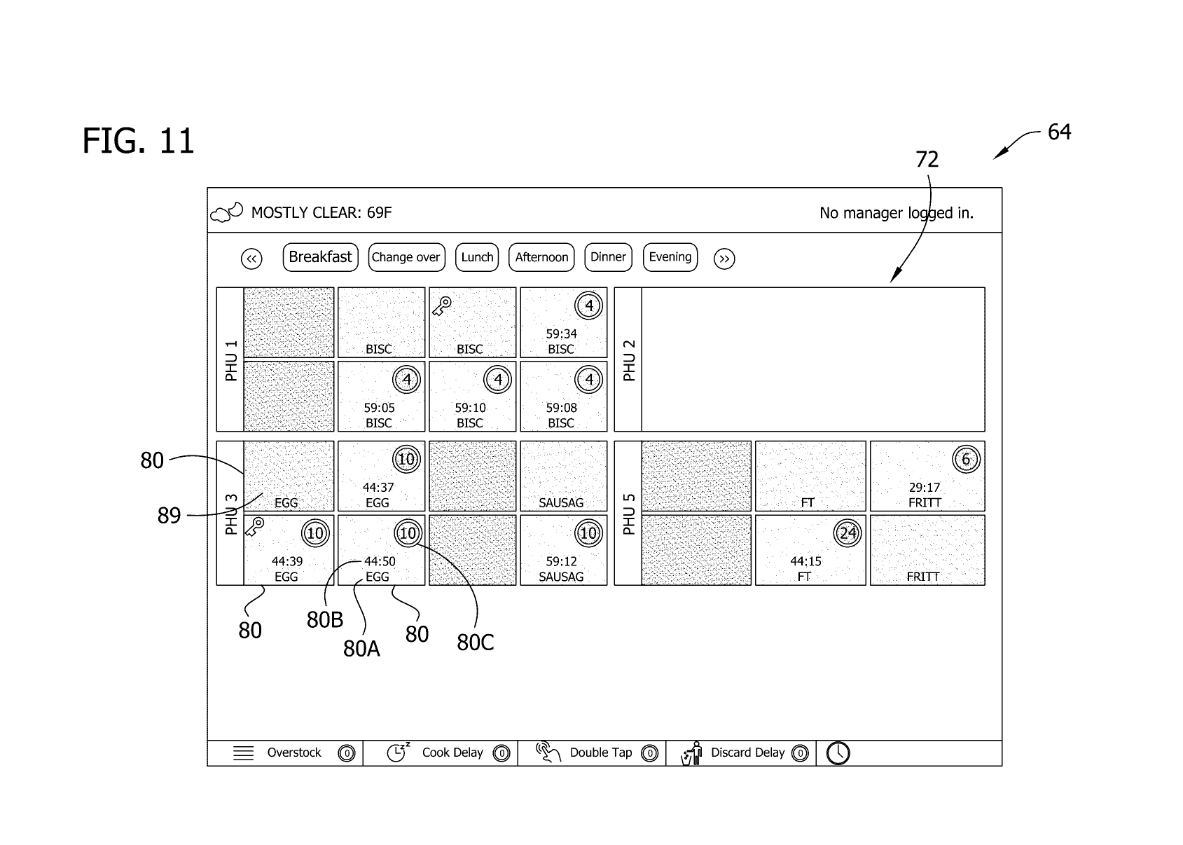

Alternatively, if the employee desired to make a “selected transfer,” they could, for example, during the pending transfer countdown time, tap the pending transfer window 100 to signal the master control system 40 to execute a selected transfer instead of a default transfer. An example of such a process is illustrated in FIGS. 9-12. The bottom right EGG holding location display 80 is illustrated as being long held by gray shading in FIG. 9. This brings up the pending transfer window 100, as shown in FIG. 10. Tapping the pending transfer window 100 makes the window disappear, after which the employee may tap the holding location display 80 representative of the desired or selected destination holding location. FIG. 11 illustrates the employee tapping the top left EGG holding location display 80 (e.g., indicated by the gray shading). In response to this user input, the controller 42 executes the selected transfer or default transfer override instructions in the tangible storage medium 44. The processor 42 transfers the food amount indicator 80C and hold time indicator 80B of the origin holding location display 80 (the bottom right EGG location 36) to the holding location display 80 of the selected destination holding location (the top left EGG location 36), rather than to the holding location display representing the default holding locations 36, which in the case illustrated in FIG. 11 already contained food.

It will be appreciated that default and selected transfer operations may be initiated and executed in other fashions without departing from the scope of the present invention. For example, a transfer may be initiated by briefly tapping the holding location display 80 of the origin location to bring up a prompt window similar to the window 90 shown in FIG. 5. The prompt window would include the same features of the window 90 described above and also includes two transfer buttons, namely a default (primary) transfer button and a selected transfer button. If the default transfer button is used, the prompt window would disappear, and the food amount indicator 80C and hold time indicator 80B would transfer to the default holding location display 80. If the selected transfer button were used, the prompt window would disappear, and the food amount indicator 80C and hold time indicator 80B would transfer to a selected destination holding location display after it is tapped by the employee. In other words, using the selected transfer button overrides the instructions in the tangible storage medium 44 identifying the default destination holding location as the only destination holding location and permits the user to select a desired destination holding location. As another example, the button 89 of the origin holding location display 80 could be actuated by the “sustained pressing and dragging” user engagement type mentioned above, in which the dragging is toward the default holding location and the user engagement is released before reaching the default holding location, could initiate or execute the default transfer. The controller 42 may be responsive to the dragging to show the holding location display 80 or other image moving on the touch screen display 64 in the direction of the dragging. Moreover, if the user desired to perform a selected transfer to a location 36 other than the default holding location, the user could sustained press the button 89, drag the holding location display 80 or other representative image, and drop it on a selected destination holding location display.

In one embodiment, the control system 40 may include at least one sensor 110 used for initiating a transfer. For example, as shown in FIGS. 1, 1A, and 2, sensors 110 may be provided on the food holding apparatus 20 at respective food holding locations 36. The sensors 110 may be adapted for sensing whether food is present at the holding locations 36. Various types of sensors 100 may be used, such as weight sensors, pressure sensors, presence sensors, optical sensors, or other types of sensors. For example, if the primary holding location for a particular type of food is indicated on its holding location display 80 as not holding food, and a sensor 110 associated with a holding location 36 indicated as holding food of the same type signals the control system 40 that the pan has been removed from that holding location, the control system may automatically initiate or execute a default transfer, i.e., transfer the food amount indicator 80C and hold time indicator 80B to the primary (default) holding location display. It is assumed that the employee has removed the food from the non-primary holding location 36 to transfer the food to the primary holding location from which the food will be served. Moreover, if a sensor 110 in the default destination holding location (e.g., primary holding location) signals the controller 42 that there is no food present in that location, and the controller may execute instructions stored in the tangible storage medium 44 for initiating or executing a default transfer of food held in another holding location to the default destination holding location. For example, when the primary (default destination) holding location for a particular food type becomes empty, and food of that type is being held in another holding location, the controller 42 may provide a prompt or alert to the user, or provide a suggestion to the user which they may accept or decline via user input, to transfer the food to the default destination holding location (e.g., upon the user accepting via user input). A similar default transfer could be initiated or executed by the controller 42 without using a sensor 110 but instead monitoring statuses of holding locations (as displayed by the holding location displays). For example, if a default destination (primary) holding location for a particular type of food is indicated by its holding location display 80 as not holding food, and another holding location is indicated by its holding location display as holding that type of food, the controller 42 may initiate or execute a default transfer from that holding location to the default destination holding location. If more than two holding locations 36 other than the default destination holding location are shown as holding food, the origin holding location for the default transfer would be identified as the holding location having a “serve first” status (e.g., green color displayed by the respective holding location display 80). This step of identifying the origin holding location between two potential origin holding locations could also be used in a transfer involving a sensor signaling the default destination holding location is not holding food.

When food at a holding location 36 is indicated on its holding location display 80 as containing expired food (hold time elapsed, e.g., “0:00”), the amount of expired food represented as held in the holding location may be updated. For example, to indicate to the master control system 40 that the expired food is being discarded, the employee may tap on the holding location display 80 representative of the relevant holding location 36. The prompt window 90 such as shown in FIG. 5 would appear. The food amount last indicated by the food amount indicator 80C would appear in the food amount input field 90A. This amount represents the suggested amount of wasted food. If the amount is correct, the employee may use the waste button 90D to reset or clear the holding location display 80 (i.e., remove the hold time indicator 80B and food amount indicator 80C, and change the displayed status from “food held” to “food not held” such as by color change). If the amount is incorrect (e.g., not accurately representative of the amount of food in the pan to be discarded), the employee may correct the amount using the delete button 90C and/or the number buttons 90B and then use the waste button 90D to reset/clear the holding location display 80. The control system 40 logs the amount of food last shown in the food amount input field 90A in the tangible storage medium 44 as wasted food. After the holding location display 80 has been cleared (i.e., the food has been wasted), the holding location display no longer shows a hold time indicator 80B or food amount indicator 80C, shows “no food held” status, and is ready for the employee to initiate another hold sequence per the steps described above.

In view of the discussion above, it will be appreciated that the buttons 89 of the touch screen display 64 associated with the holding locations 36 permit execution of different operations by different activations or actuations of the buttons by different types of user engagement with the buttons. For example, in one embodiment, as described above, tapping (a first type of engagement) of a button 89 for a holding location display 80 brings up the prompt window 90 (e.g., from which the amount of food indicated as stored at the location 36 can be changed or a transfer may be initiated), and long holding or sustained pressing (a second type of engagement) of the button executes a transfer. In other embodiments, a default transfer may be initiated or executed by tapping and a selected transfer may be initiated or executed by long holding. As also described above, upon inserting food into a previously empty holding location 36, tapping the button 89 associated with the holding location display 80 may bring up the prompt window 90, and sustained pressing the button may automatically enter the suggested amount of food (e.g., previously displayed on the cook list). Moreover, as also described above, upon expiration of the hold time, tapping the button 89 may bring up the prompt window 90 (where the amount of food to be wasted can be modified), and long holding the button may automatically log the suggested amount of food as waste and change the displayed status of the holding location 36 to “no food held.” It will be understood that other operations may be executed based on other types of engagements with the touch screen display, and the operations initiated or executed by tapping, long holding, or other types of engagements may be switched or interchanged without departing from the scope of the present invention. It will be appreciated that the appearance of the buttons 89 is substantially the same for a particular food holding location display among the various holding location statuses, other than the updating of displayed information representative of the status of the holding location in the touch sensitive area of the holding location display defining the button. For example, a button appears substantially the same among holding location statuses except for the updating of displayed indicators representing food type, amount, hold time, whether food is present, whether food should be served first or second, and whether food is expired. However, other configurations may be used without departing from the scope of the present invention.

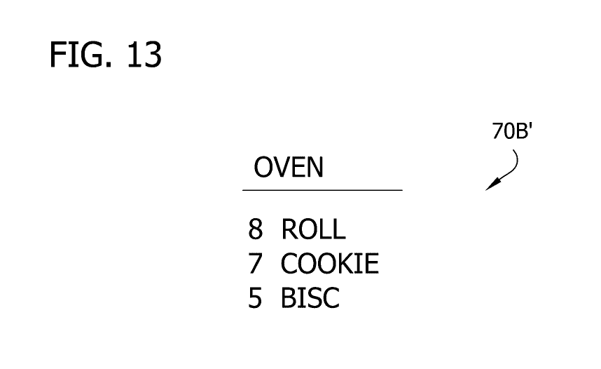

In another aspect of the present invention, the cook list section 70 may display food types to cook in order of floating priority. This will be described with reference to FIGS. 13-15, which illustrate schematically a variable cook list 70B′ that may be displayed in the cook list section 70 of the view of the touch screen display 64 of FIG. 3. It will be appreciated that the cook list 70B′ illustrated in FIGS. 13-15 is specifically for an oven, and cook lists for other appliances and global cook lists (including food types cooked by different appliances) may be used according to the principles explained herein (e.g., as shown in FIG. 3), without departing from the scope of the present invention. The cook lists may be updated in substantially real-time, on a delayed basis, and/or periodically, based on the determined priority or need for cooking certain food types. In other words, the cook list can be described as being variable or changing based on need for food. Priority for cooking certain types of food may be determined by a ratio of “inventory” versus “need.” The food that is in inventory (on hand) includes the food ready to be served (e.g., cooked food) and can be determined by summing the amount of food of the particular type indicated as currently held in the food holding apparatus 20 (e.g., summing the amount represented by the food amount indicators 80C for all holding locations 36 holding that food type). The amount of food of each type that is needed (demand) can be determined by forecasting or predicting, as described above, for predetermined intervals of time. For example, if it is predicted 10 biscuits will be needed in the next 30 minutes (or other pre-determined time increment or increments), and there are 5 biscuits currently in inventory, the ratio of inventory versus need for biscuits would be 5:10 or 50%. If it is predicted 10 cookies will be needed in the next 30 minutes, and there are 3 cookies in inventory, the ratio of inventory versus need for cookies would be 3:10 or 30%. Accordingly, cookies (e.g., “7 COOKIE”) would be displayed on the oven cook list 70B′ as having higher priority (e.g., above) biscuits (e.g., “5 BISC”). This is illustrated in the cook list 70B′ shown in FIG. 13. In general, food types having smaller inventory versus need (e.g., expressed as percentage or fraction) are ranked higher in priority on the cook list than food types having greater inventory versus need. The cook list can be described as having a highest priority position indicating the food item type having the highest priority to be cooked, which in the illustrated embodiment is the top of the cook list (e.g., see “8 ROLL” in FIG. 13). It will be understood that the ratio of inventory versus need can also be expressed as need versus inventory, in which case the food types having higher need versus inventory would be ranked higher in priority on the cook list than food types having lesser need versus inventory. Moreover, it will be understood priority can be determined as a function of inventory and need in other ways without departing from the scope of the present invention. For example, factors, parameters, and/or multipliers in addition to the ratio can be included in determining priority, and the ratio can account for or be a function of other factors, parameters, and/or multipliers.

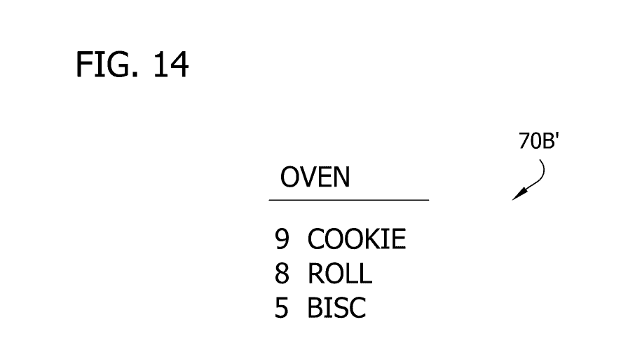

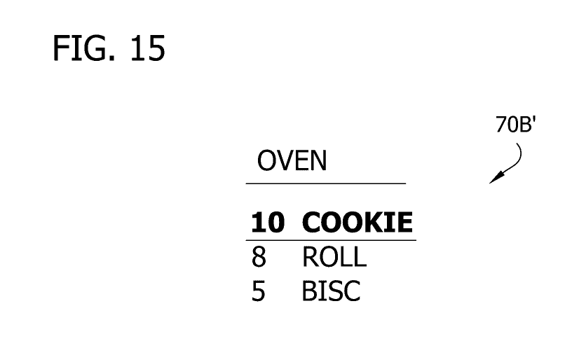

The ratio of inventory versus need of a particular food type may change over time, and the cook lists may be updated to reflect the changed priority. The tangible storage medium 44 can store the cook list and priority information (e.g., in data structures), and the controller 42 can update the priority information and modify the cook list accordingly. Continuing with the example from above, if the point-of-sale device 24 indicates to the master control system 40 that a customer has recently ordered two cookies, the inventory of the cookies will be updated to 1 cookie (2 less cookies than before). The food amount indicator 80C on the holding location display 80 associated with the holding location holding cookies from which they are being served (e.g., the primary holding location) would be updated to 1 from 3. Accordingly, the ratio of inventory to need of cookies would reduce to 10%, meaning there would be increased priority to cook cookies. If the updated inventory to need of cookies changed the relative priority on the cook list 70B′ (e.g., relative to rolls at 20%), cookies would move higher on the oven cook list (e.g., “9 COOKIE”), as shown in FIG. 14, in which cookies is shown in the highest priority position on the cook list. On the other hand, if the inventory of cookies increased (e.g., 6 cookies were baked and supplied to the food holding apparatus 20, as indicated to the control system 40 by the employee using the user interface 46 or specifically the touch screen display 64), the decreased priority for preparing cookies may move it lower on the cook list 70B′. If the amount of a particular food type in inventory is less than the amount of that food type currently ordered by customers, that food type may be indicated with particular importance to the employees to be cooked (e.g., on top of the cook list, flashing, bolded, underlined, or highlighted, etc.). For example, FIG. 15 illustrates emphasis for cooking “10 COOKIE,” which is bolded, underlined, and highlighted. Moreover, what is considered to be in inventory may be updated to account for hold time remaining and/or cook time for that particular food type. For example, if 10 cookies are needed, and the master control system 40 indicates 3 cookies are in inventory, but the hold time remaining for the 3 cookies is less than the time required to cook new cookies, the “inventory” of cookies for purposes of the inventory versus need ratio may be considered to be 0. Accordingly, the ratio would be 0% when the remaining hold time is less than the time required to cook new cookies, and the cookies (e.g., “10 COOKIE”) may move higher on the oven cook list 70B′ and/or be emphasized as having high priority (e.g., on top of the cook list, flashing, bolded, underlined, or highlighted, etc.), as shown in FIG. 15. Moreover, as time elapses, the amount of food of a particular food type needed to fill expected orders may change, which could accordingly affect the inventory versus need ratio.

If desired, a food type listed on the cook list 70B′ may be “held” or “locked” in position (priority) on the list by user engagement (e.g., tapping, long holding, etc.) the associated line item (e.g., the food type indicator) on the cook list. For example, if the particular food type is currently being cooked, it may be desirable to hold its position on the cook list until cooking of food of that food type is finished and the cooked food is supplied to the food holding apparatus 20. After food is cooked and supplied to the food holding apparatus 20, the master control system 40 knows cooking of the food has finished, based on entry of the food into a holding location (from an employee using the touch screen display 64 to enter the food into a holding location). In response, the master control system 40 may reduce the amount of that food type shown on the cook list as needing to be cooked or remove it from the cook list, as necessary.

The master control system 40 can be combined with a control system of any food preparation apparatus (e.g., the food cooking devices 6 and the food holding apparatus 20 of FIG. 1) to make a food preparation control module for a food management system. For example, the control module may combine the master control system 40 with a control system for a fryer to control the cooking of fried products (fries, chicken, fish, etc.), or with a control system for an oven for cooking non-fried products (e.g., bread), and/or with a food holding cabinet for holding cooked food items to be consumed, or with other food preparation apparatus. Different modules can be installed at different food preparation facilities depending on the types of food being provided.

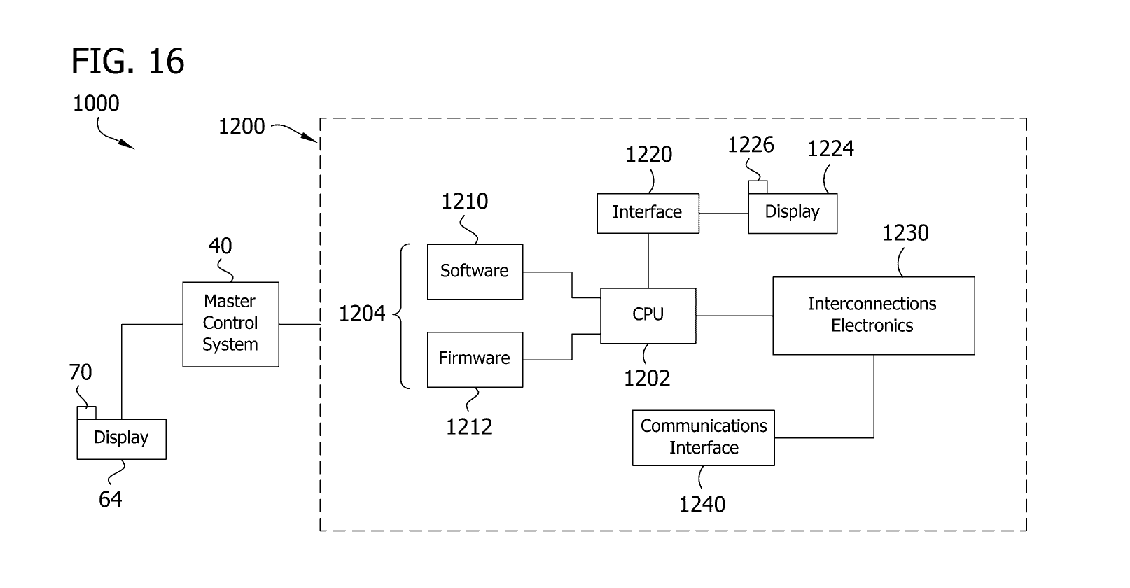

A schematic illustration of one such module 1000 is illustrated in FIG. 16. The module includes the master control system 40 described above and a control system 1200 for a food preparation apparatus, such as the oven 10. The control system 1200 comprises a central processing unit 1202 (“CPU” or broadly “controller” or “board”) including one or more processors, a tangible storage medium 1204 (e.g., including forms of storage such as software 1210 and firmware 1212), and a user interface 1220 (e.g., mounted on the food preparation apparatus) including a display 1224 for displaying various views to the user/operator. In the illustrated embodiment, the display 1224 is a touch screen display in which the screen is sensitive to the touch of the operator for receiving input signals from the operator. The CPU 1202 may be a microprocessor or the like. The control system 1200 includes interconnection electronics 1230 that operatively connect the various components of the control system 1200, including a communications interface 1240. For example, the interconnection electronics 1230 may include electrical or fiber optic lines or wireless communication devices. The communications interface 1240 may include wired or wireless communications devices or connectors (e.g., USB flash drive port, other types of data ports, modems, wireless signal transmitters/receivers, etc.) for importing and exporting information to and from the control system 1200. The controller 1202 is adapted for reading and executing processor executable instructions stored in the storage medium 1204 and is responsive to the user interface 1220 for controlling the various components and systems of the control system 1200.

The master control system 40 and apparatus control system 1200 share information (e.g., via the communications interfaces 50 and/or 1240), such that at least some of the information displayed on the display 64 of the master control system is also displayed on the apparatus display 1224, and vice versa. By way of example but not limitation, the apparatus display 1224 may have a cook list section 1226 (FIG. 16) with a prioritized list of food products corresponding to the prioritized list of such food items in the master cook list section 70 of the master display 64 (e.g., list 70B in FIG. 3 if the apparatus is the oven 10). Changes affecting the demand for and/or current inventory of food items, such as the placement of orders at the POS and/or the completion of a cooking process increasing the inventory of cooked food items, are made substantially simultaneously to the cook list sections 70, 1226 of both displays 64, 1224.

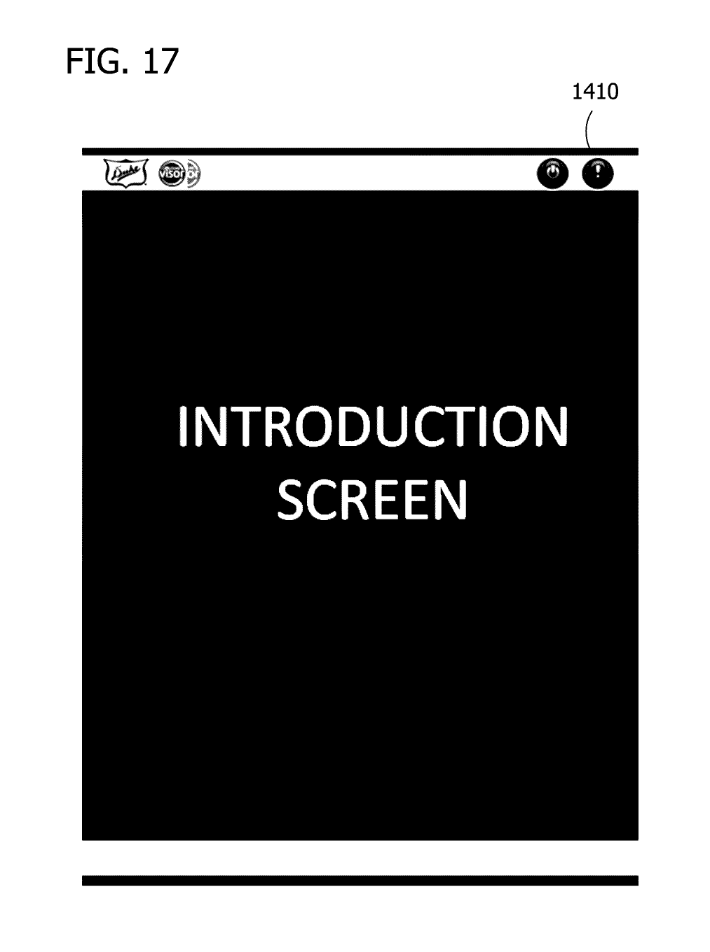

FIGS. 17-34 are a series of screen shots (graphic interface) illustrating example functionality of the control system 1200 as a control system for a food cooking device 6 with the touch screen display 1224 of the user interface 1220. The control system 1200 is programmed to display the information on the screen as a function of, among other things, operator input and other components of the food cooking device 6, as will become apparent.

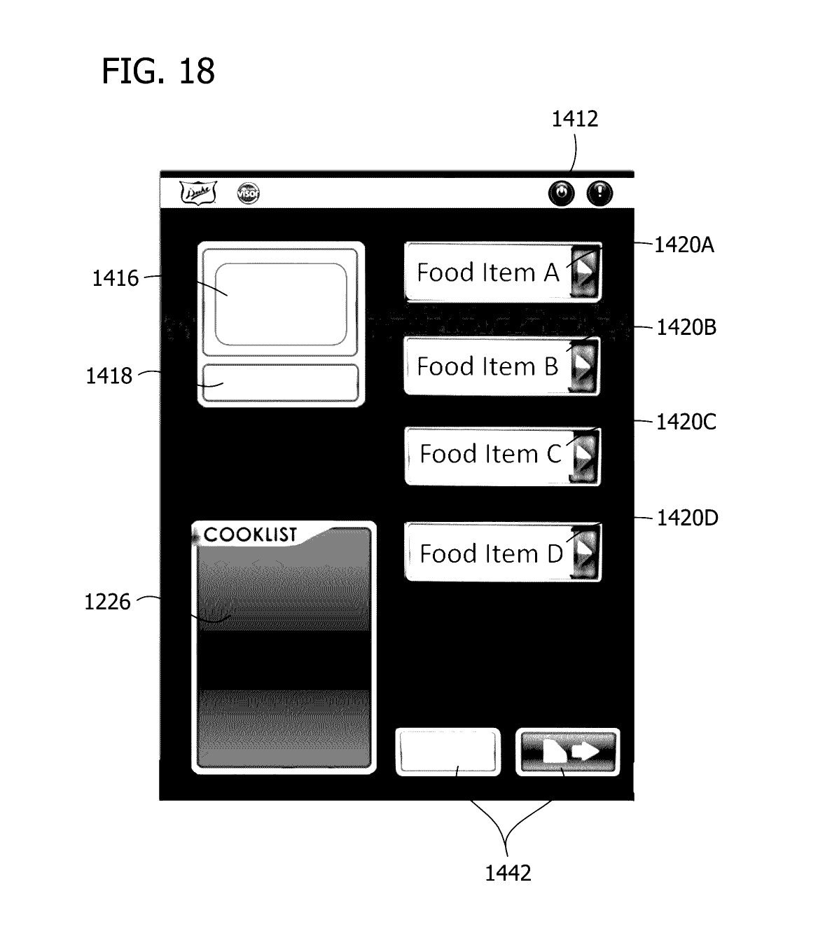

FIG. 17 is an initial introduction screen 1410 which opens upon power-up of the food cooking device 6. The screen 1410 displays general information about the food cooking device 6 (e.g., manufacturer, legends, etc.). In one embodiment, the screen 1410 automatically transitions to the next screen (FIG. 18).

FIG. 18 is an off-state screen 1412 (meaning that the oven 10 is in an “off” condition) which opens after the initial screen 1410 closes. Screen 1412 includes a food cooking device icon 1416, a power button 1418, a recipe button section having a series of recipe buttons (cook recipe buttons) 1420A-1420D identifying different types of food items, a cook-list graphic 1226, and forward and backward navigation buttons 1442. In the illustrated embodiment, the recipe button section is separate from and next to the cook-list graphic. (As used above and below, the term “button” is intended to include any type of actuating device, e.g., toggle switch, push-button switch, rotary switch, rocker switch, or a graphic representation of a physical button on a screen, or a graphically distinguishable location on a screen, etc.)

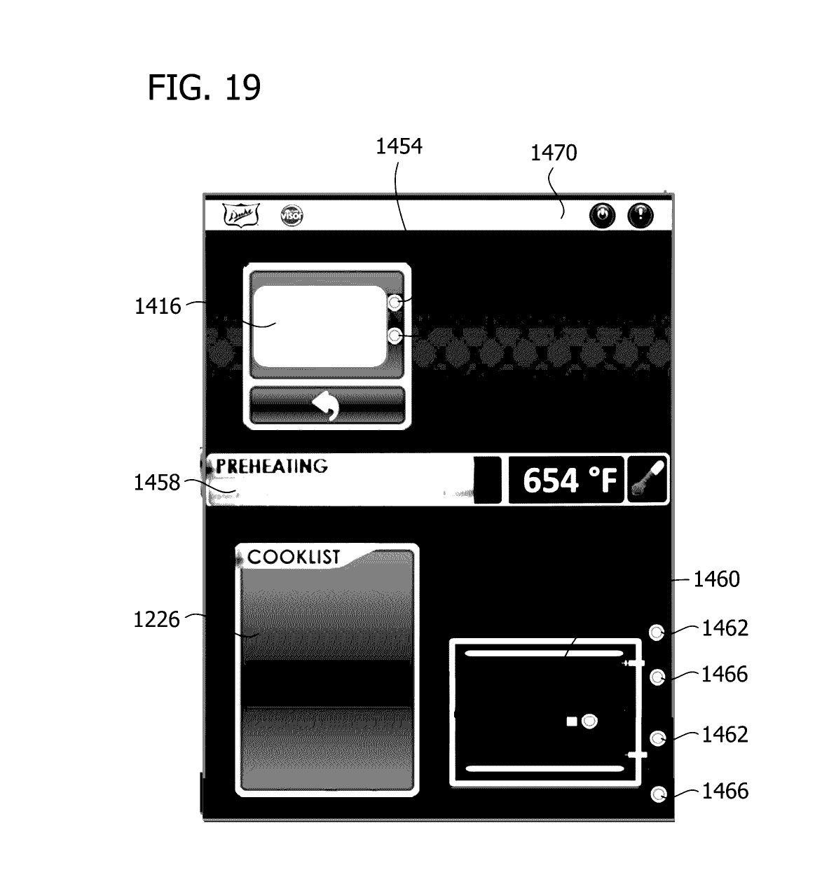

To start a cooking device preheat cycle, the operator presses the power button 1418 or a recipe button 1420A-D, which opens the screen of FIG. 19.

FIG. 19 is a preheat screen 1450 displaying the food cooking device icon 1416 with status indicators 1454 indicating that both upper and lower heat sources are “on”, the cook-list graphic 1226, a pre-heat bar 1458 displaying the status (progress) of the preheat cycle and the temperature in the food cooking device 6. The screen 1450 also includes an animated cooking device section graphic 1460 with status indicators 1462 indicating the operational status of upper and lower heat sources and status indicators 1466 indicating the operational status of sensors associated with each of these heat sources. The screen also includes a message field 1470 for displaying an appropriate message, such as “DO NOT COOK.”

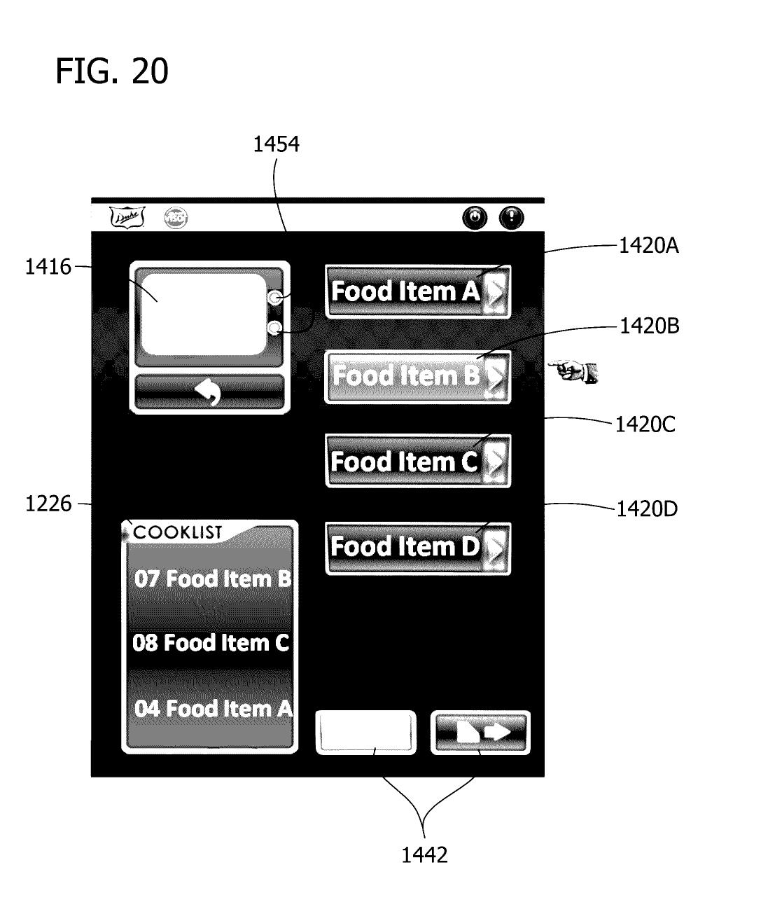

FIG. 20 is a “ready” screen 1474 displaying the food cooking device icon 1416 and status indicators 1454 indicating that the lower heat source is “on” and the upper heat source is “off”, the recipe buttons 1420A-1420D, and the navigation buttons 1442. The screen 1474 also includes the cook-list graphic 1226 which contains information corresponding to information on the cook list section 70 of the touch screen display 64 of the master control system 40 described above. Desirably, this information includes a variable cook list of different types and numbers of food items 1480A, 1480B, and 1480C to be cooked in the food cooking device 6.

As noted above, the food cooking device control system 1200 desirably communicates with the master control system 40 via the communications interface 50 of the master control system and the communications interface 1240 of the food cooking device control system. Further, the master control system 40 and the food cooking device control system 1200 are programmed to communicate with one another such that any changes to the information related to the food cooking device displayed on the cook list section 70 immediately transfers over to cook list graphic 1226, and vice versa. Thus, the variable list of different types of food items on the cook-list graphic 1226 is prioritized in the same way as the variable list of food items related to the food cooking device displayed on the cook list section 70, i.e., according to the sequence in which they are to be cooked by the food cooking device, with the food items of highest priority to be cooked first being at the top of the list (highest priority position) and other types of food items being arranged below in a descending order of priority.

To begin a cooking process, a batch of food items corresponding to the highest priority food item on the cook-list graphic 1226 (“Food Item B”) is loaded into the food cooking device 6. The operator then presses a cook recipe button 1420A-1420D also corresponding to the highest priority food item on the cook-list graphic 1226 (“Food Item B”). In one embodiment, the highest priority food item button flashes or otherwise signals the operator to “pick me” to emphasize to the user or draw the user's attention to the button associated with the highest priority food type. In the illustrated embodiment, recipe buttons 1420A, 1420C, 1420D are shown in blue color, and the recipe button 1420B for Food Item B is shown in red color rather than blue color to differentiate the Food Item B button. In other words, the recipe button section can change in appearance as a function of the food item type in the highest priority position of the cook list, to draw the user's attention to the correct recipe button. More specifically, the series of recipe buttons can change in appearance as a function of the food item type in the highest priority position of the cook list, to draw the user's attention to the correct recipe button. Even more specifically, the button associated with the food type in the highest priority position of the cook list can change in appearance as a function of the food item type in the highest priority position of the cook list, to draw the user's attention to the correct recipe button. The actuation of the button 1420 signals the control system 1200 to initiate a cooking cycle during which the food cooking device follows a predetermined cooking recipe appropriate for the food items to be cooked. By way of example, the cooking cycle may include one or more phases each of which is for a specified duration of time, at a specified cooking chamber temperature, and with one or more heat sources energized.

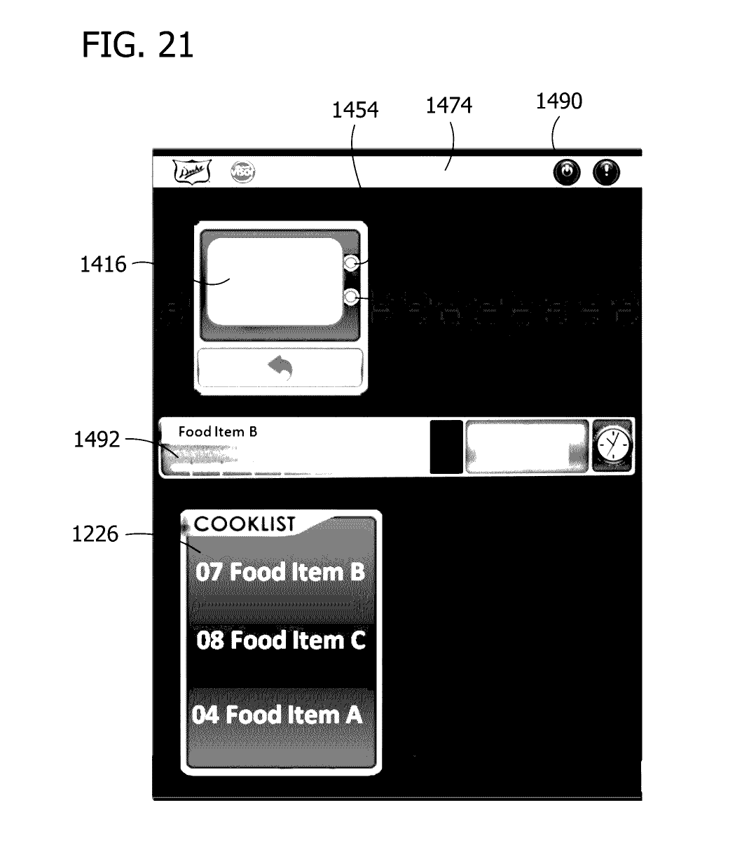

FIG. 21 is a “Food Item B cook progress” screen 1490 which opens when the food item to be cooked is selected by touching the appropriate recipe button 1420A-1420D on the preceding screen (FIG. 20). The cook progress screen 1490 includes a visual cooking progress bar 1492 displaying the progress of a cook cycle for the selected product, a decrement timer 1496 displaying the remaining time in the cook cycle for the food items being cooked by the food cooking device (e.g., 15 seconds in FIG. 21), the food cooking device icon 1416 and status indicators 1454 indicating that both upper and lower heat sources of the food cooking device are “on”, and the populated cook-list graphic 1226.

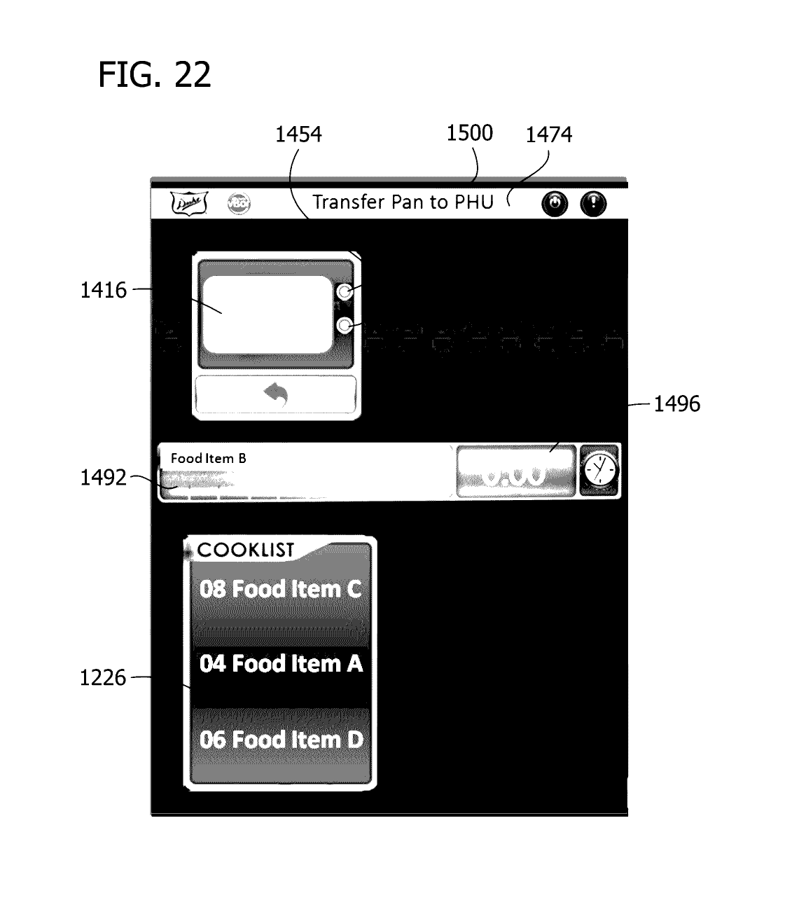

FIG. 22 is a “Food Item B cook cycle ended” screen 1500, including the visual progress bar 1492, the decrement timer 1496, the populated cook-list graphic 1226, and the food cooking device icon 1416 with status indicators 1454 indicating that both upper and lower heat sources of the food cooking device are “on”. The decrement timer reading 0:00 indicates that the cook cycle for a batch of selected food items has ended.

After the cook cycle has ended, the food is removed from the food cooking device 6. The message field 1474 on the screen 1500 includes a message to “transfer pan”, i.e., to transfer the pan of the cooked “Food Item B” items to a suitable location. The cook list section 70 of the display 64 of the master control system 40 is automatically updated to delete the type of food item (“Food Item B”) just cooked and to move the type of food item next on the priority list (“Food Item C”) to the top of the list. This update is also automatically made to the cook-list graphic 1226, as shown on the screen 1500.

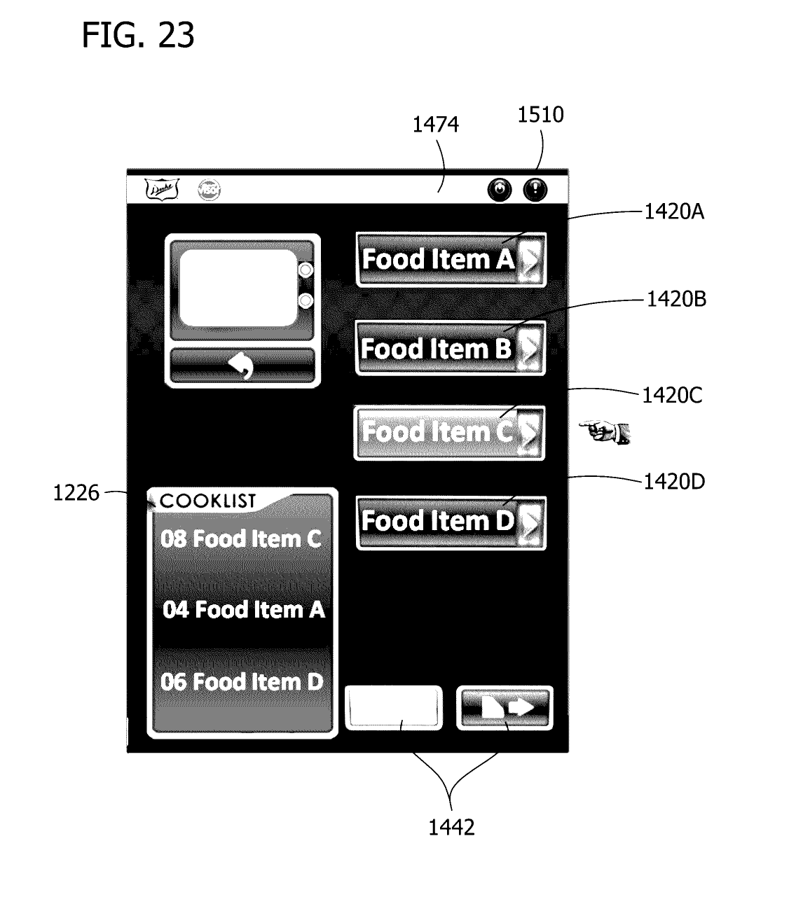

FIG. 23 is a “ready” screen 1510 indicating that the food cooking device 6 is ready to cook the next batch of food items. The screen 1510 is similar to screen 1474 except that the cook-list 1226 is updated to show that “Food Item C” food items are to be cooked next. These items are then loaded into the food cooking device, and the recipe button 1420C is pressed to begin a cook cycle. As explained above, in one embodiment, the highest priority food item button flashes or otherwise signals the operator to “pick me.” In the illustrated embodiment, the recipe button 1420C for Food Item C is shown in red color (changed from blue color to red color) and the other recipe buttons 1420A, 1420B, 1420D are shown in blue color (the recipe button 1420B changed from red color to blue color) to differentiate the Food Item C button. In other words, the recipe button section, more specifically the series of recipe buttons, and even more specifically the recipe button 1420C associated with Food Item C (in the highest priority position of the cook list), can change in appearance based on Food Item C being in the highest priority position of the cook list.

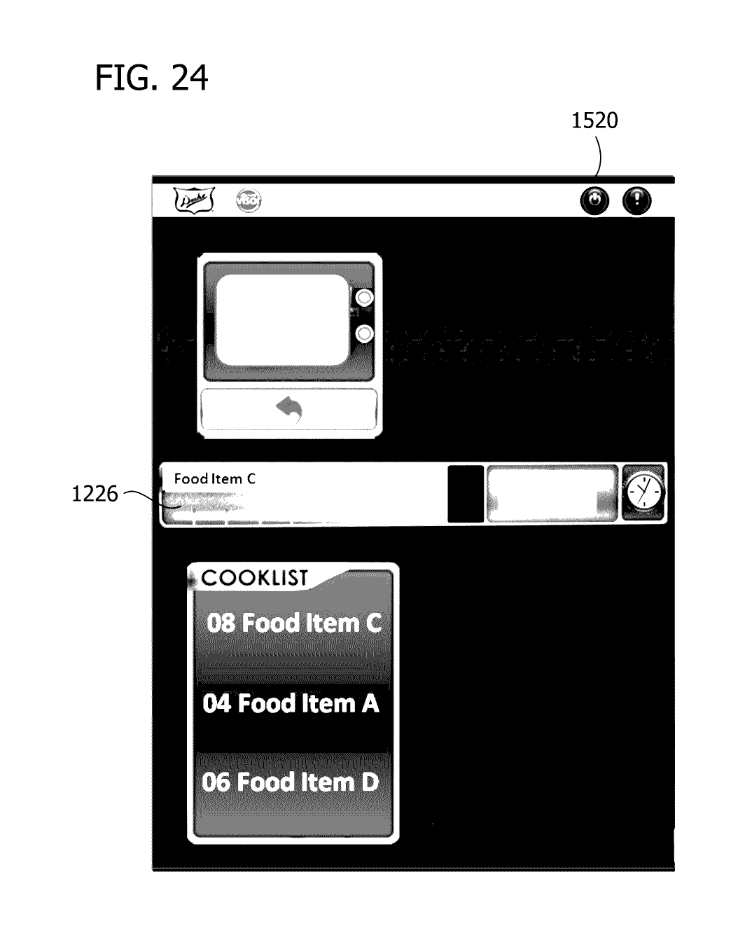

FIG. 24 is a “Food Item C cook progress” screen 1520 similar to FIG. 21. The visual progress bar 1492 displays the remaining time in the cook cycle for the “Food Item C” food items being cooked by the food cooking device.

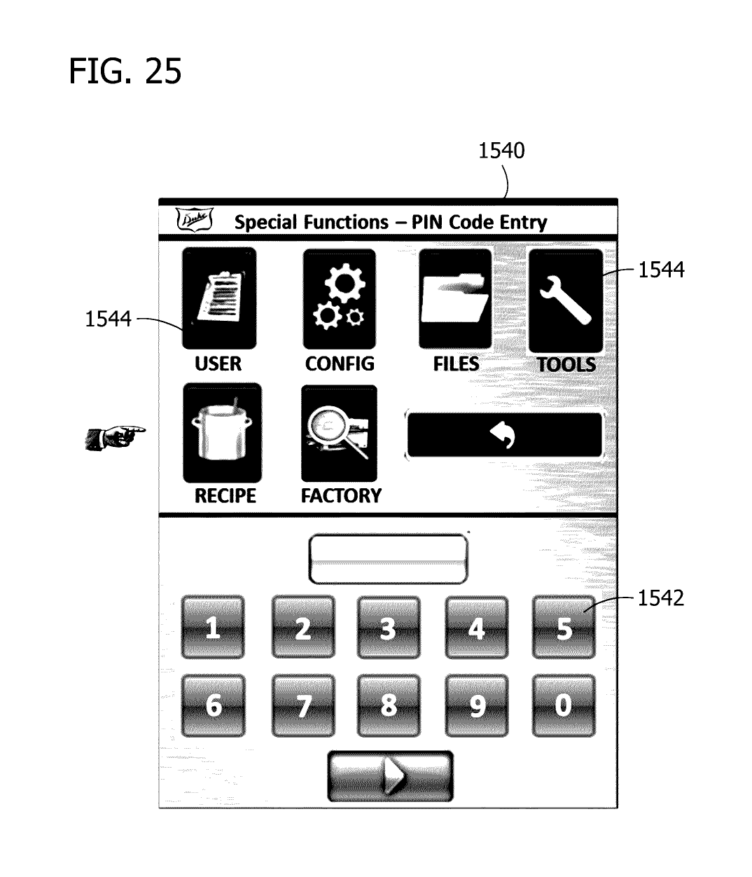

FIG. 25 is a “special functions” screen 1540 including a number keyboard 1542 for inputting a PIN code to access special function features of the control system 1200. The screen 1540 also includes various icons 1544 indicating different functions of the control system, including a user icon, a configuration icon, a files icon, a tools icon, a recipe icon, and a factory icon. Other icons may be displayed.

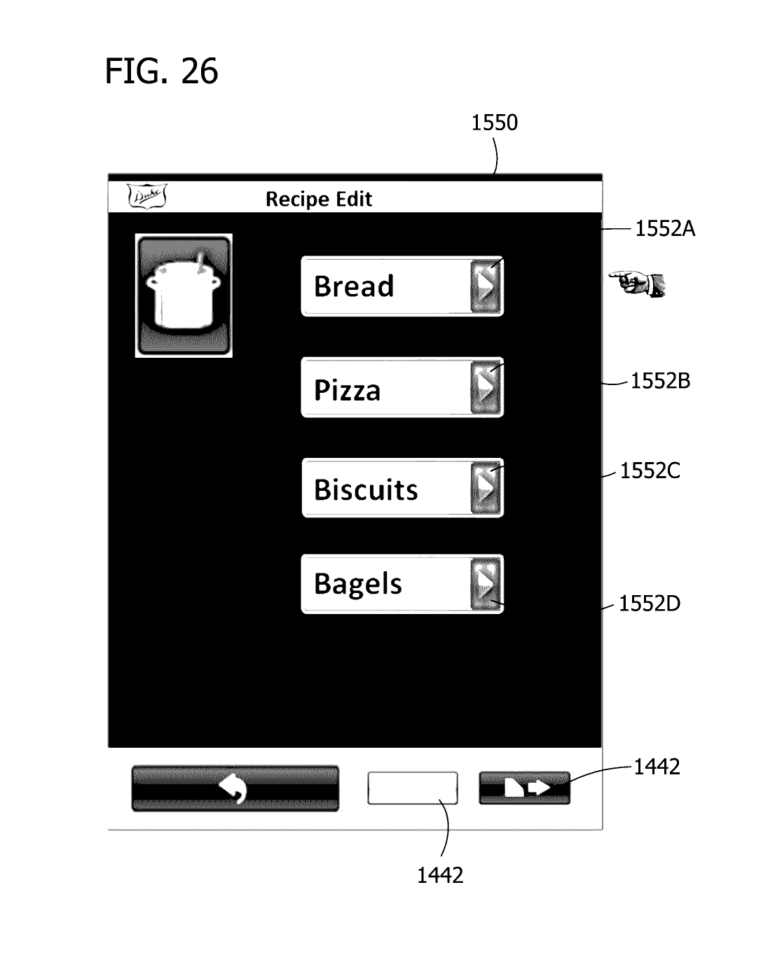

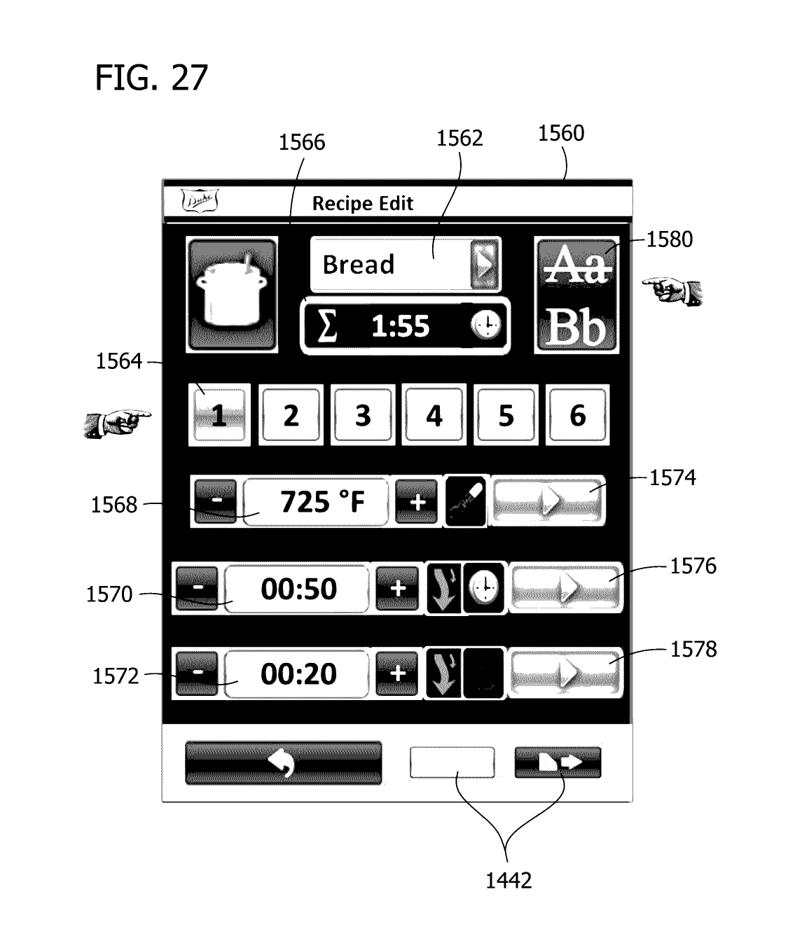

Optionally, the master control system 40 and/or the food cooking device control system 1200 are programmed to allow a recipe for a food item to be modified. FIGS. 26 and 27 are screen shots of the master display 70 and/or the food cooking device display 1224 displaying an exemplary manner for modifying a cook recipe.

FIG. 26 is a “recipe edit” screen 1550 displaying a number of recipe buttons 1552A-1552D identifying different types of food items (e.g., bread, pizza, biscuits, and bagels) to be cooked in a food cooking apparatus 6 such as the oven 10. In this screen, the “bread” recipe button 1552A is selected, which opens the screen of FIG. 27.

FIG. 27 is a “recipe edit cook parameter” screen 1560, including a display 1562 indicating the selected food item (e.g., bread), and a series of cook cycle phase number buttons 1564 for selecting different cook cycle phases to be programmed (phase 1 is selected on the screen). Exemplary cook parameters to be programmed for each cook cycle phase include time, temperature, and the on/off condition of one or more heat sources of the oven, such as a microwave heat source, a convective air heat source, an IR heat source, a steam heat source, or any combination thereof. The screen 1560 includes a display 1566 indicating the total cook time of a selected recipe (including the sum of the times for each cook cycle phase), a cook phase temperature readout 1568 which can be incremented or decremented to set the temperature of the selected cook cycle phase, a first heat source timer 1570 which can be incremented or decremented to select the time a first heat source is “on” during the selected cook cycle phase, and a second heat source timer 1572 which can be incremented or decremented to select the time the first heat source is “off” during the selected cook cycle phase. The sum of the “on” time and “off” time is the duration of the selected cook cycle phase (the first cook cycle phase in FIG. 27) The screen 1560 also includes save buttons 1574, 1576, 1578 to save the programmed settings of the selected cook cycle phase. A letter button 1580 is provided on the screen for opening another screen enabling an operator to change the name or names of the food items.

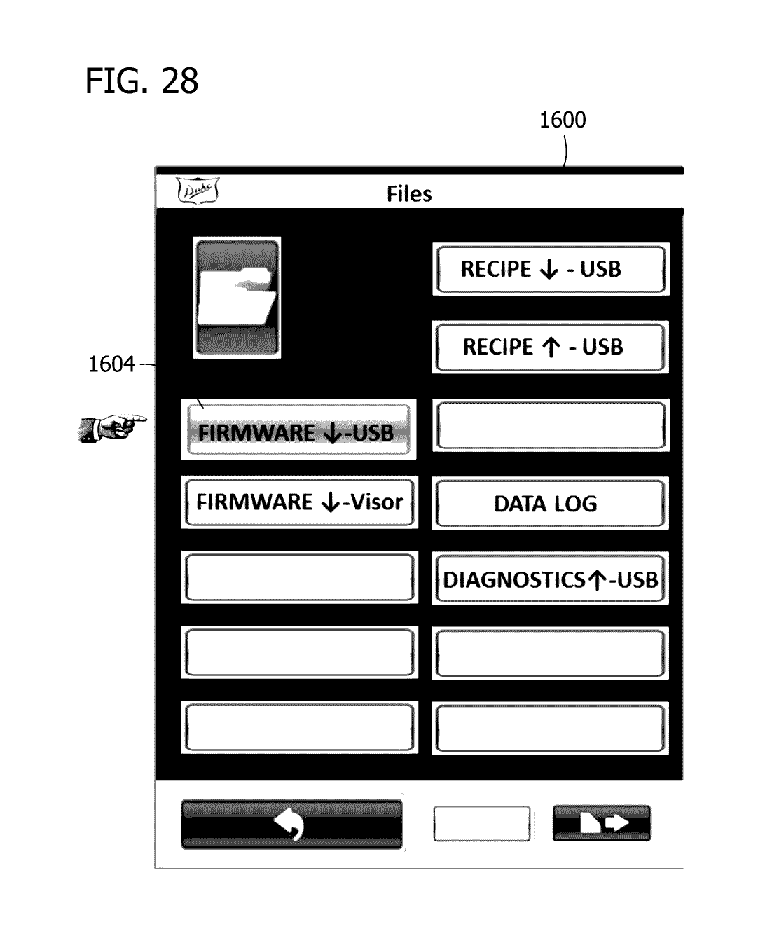

FIG. 28 is a “files and firmware update” screen 1600 displaying a number of buttons 1604 labelled by functionality, including a “Firmware-USB” button 1604. The appropriate buttons are pressed to import and export operating system and data files via the communications interface 1240.

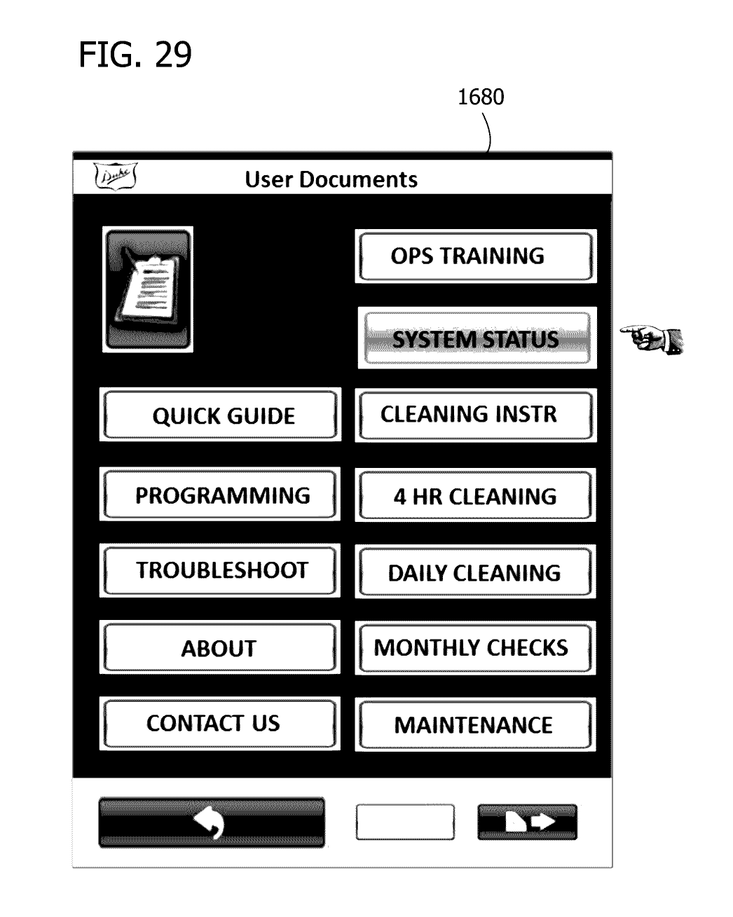

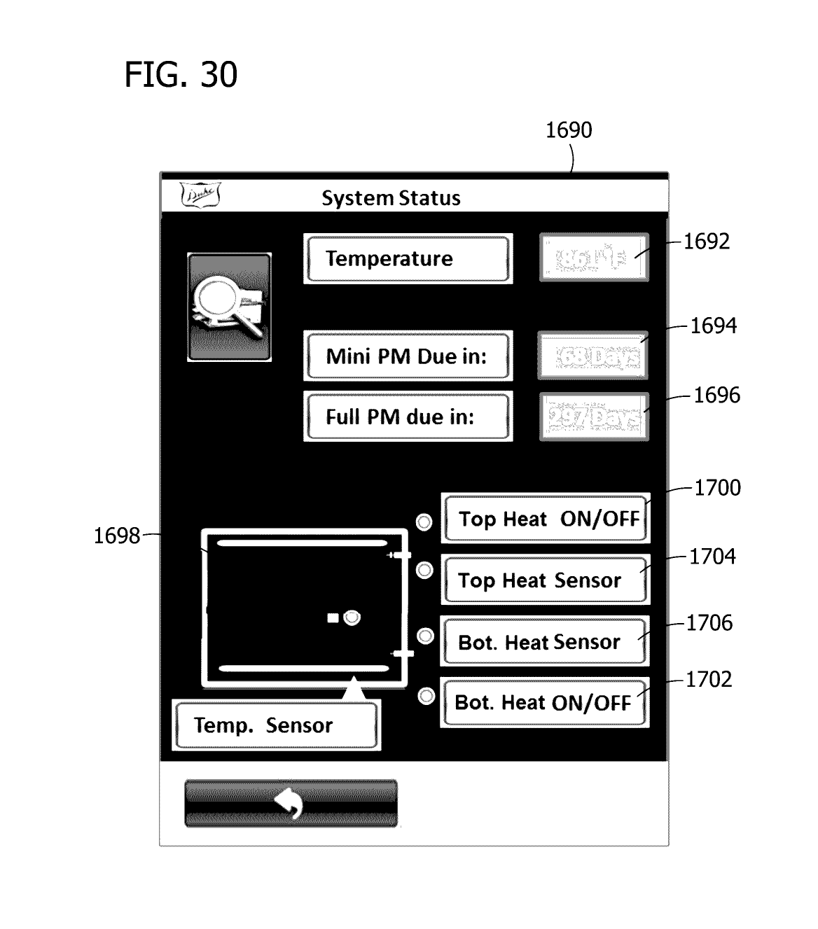

FIG. 29 is a “user documents screen” 1680 showing a “System Status” button pressed to advance to the screen of FIG. 30.

FIG. 30 is a “system status” sub-screen 1690 displaying the current state of key parameters and preventative maintenance due dates. The screen includes a temperature display 1692 showing the current temperature of the food cooking device, a “Mini PM Due” display 1694 showing the number of days remaining until a relatively frequent routine preventative maintenance procedure is to be conducted on the food cooking device 6, and a “Full PM Due” display 1696 showing the number of days remaining until a more comprehensive preventative maintenance procedure is to be conducted on the food cooking device. The screen 1690 also includes an animated food cooking device section graphic 1698 with status indicators 1700, 1702 indicating the operational status of the upper and lower heat sources and status indicators 1704, 1706 indicating the operational status of temperature sensors associated with each of these heat sources.

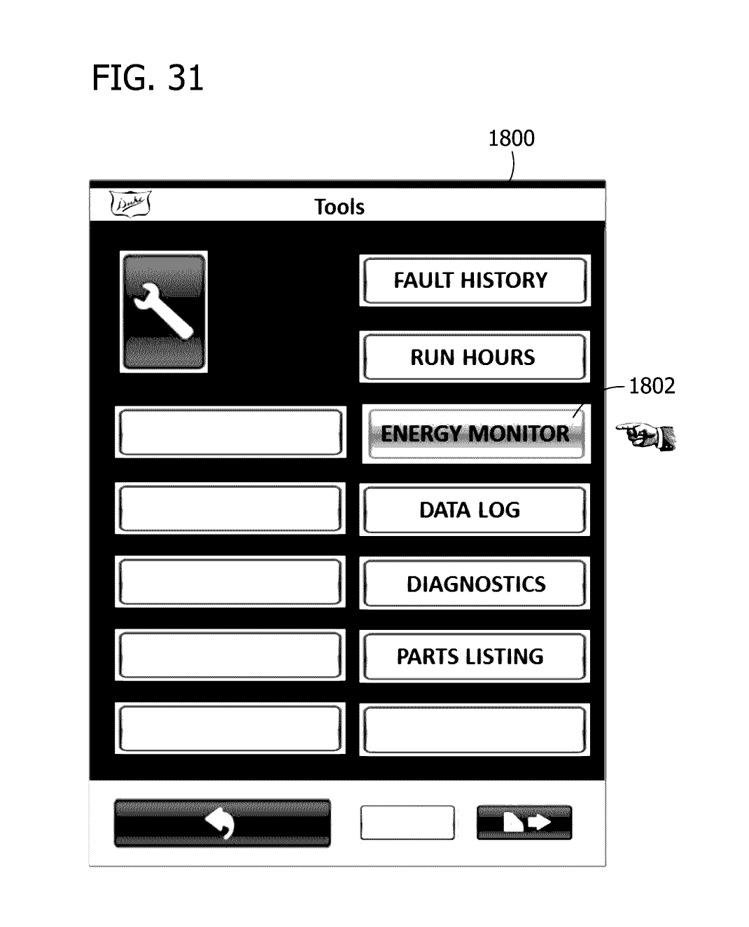

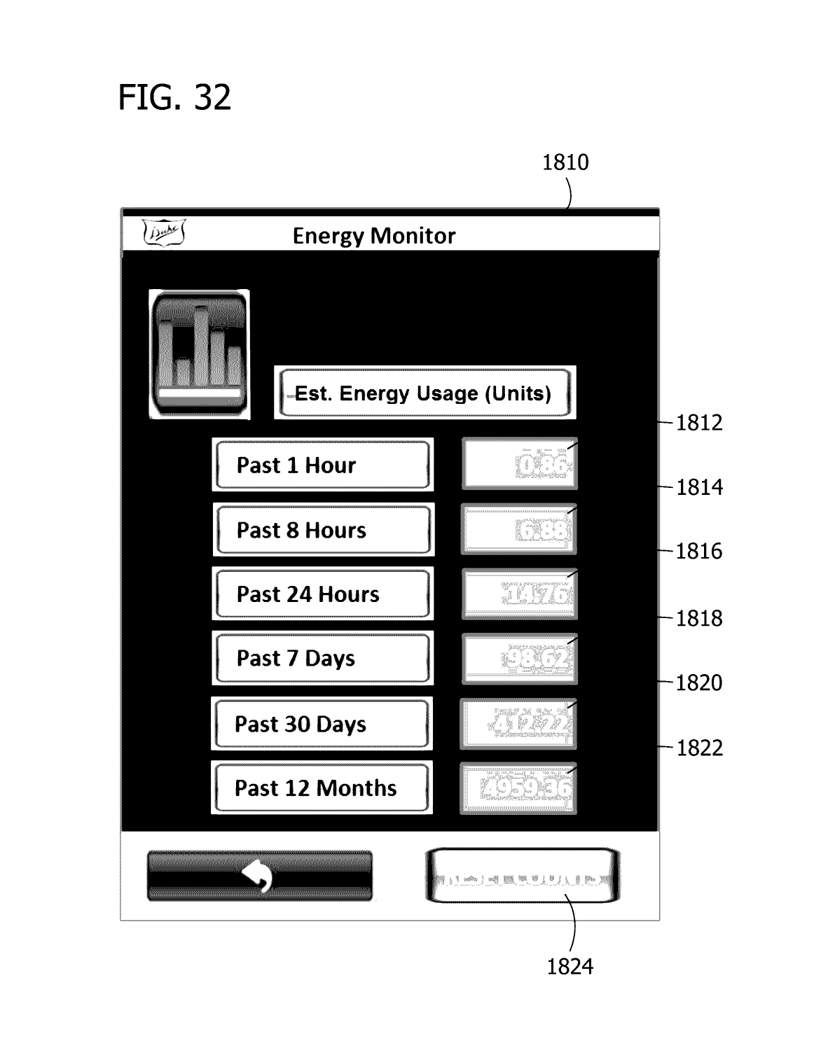

FIG. 31 is a “tools sub-screen” 1800 opened by pressing the “tools” button on the screen 1540 of FIG. 25. The screen 1800 displays a number of buttons relating to the current state of key parameters, diagnostics, and reference information, including an “Energy Monitor” button 1802 which is pressed to advance to the screen of FIG. 32.

FIG. 32 is an “energy monitor screen” 1810 including a number of displays 1812, 1814, 1816, 1818, 1820, and 1822 indicating the estimated use of energy by the food cooking device during the past 1 hour, past 8 hours, past 24 hours, past 7 days, past 30 days, and past 12 months, respectively. A reset button 1824 allows the operator to reset the displays to 0.

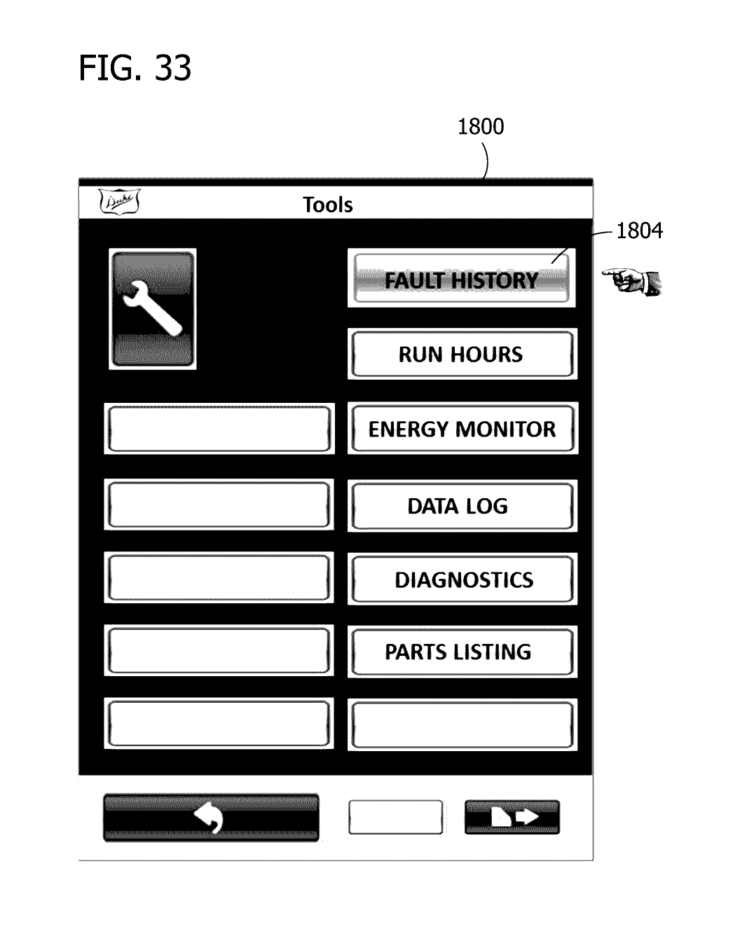

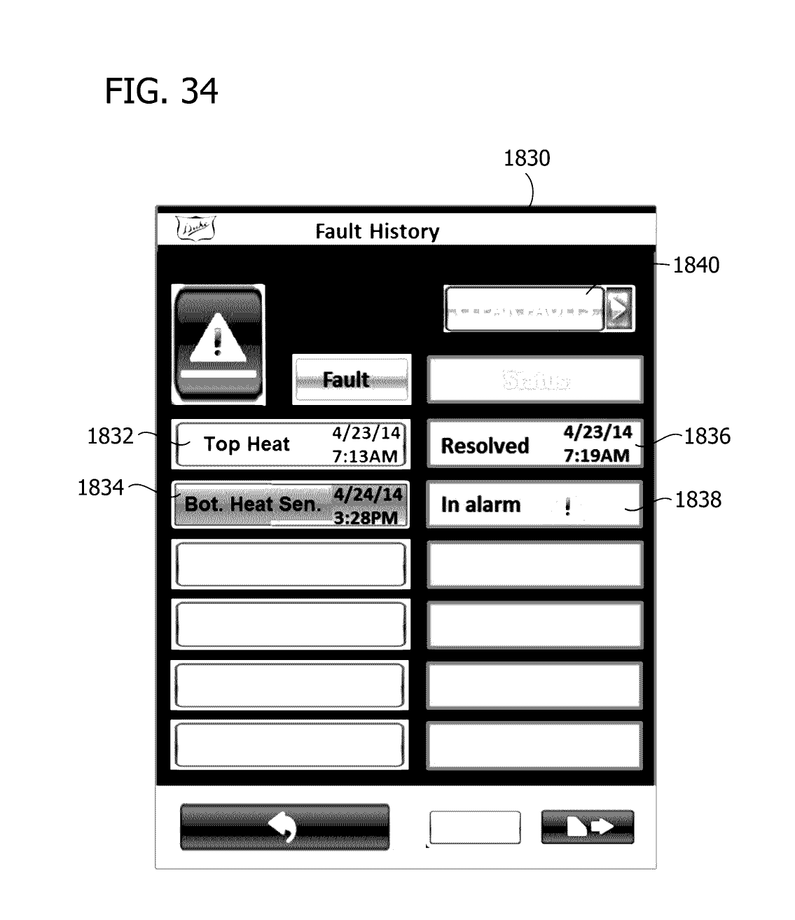

FIG. 33 is the “tools sub-screen” 1800 of FIG. 31 except that the “Fault History” button 1804 is pressed to advance to the screen of FIG. 34.

FIG. 34 is a “fault history” screen 1830 including a number of fault displays 1832, 1834 displaying recent and historical error conditions and alerts and a corresponding number of status displays 1836, 1838 displaying the current status of each such condition/alert. The screen 1830 also includes a button 840 for clearing the faults.

Communication between the master control system 40 and the apparatus control system 1200 also enables other procedures to be implemented to facilitate workflow and increase efficiency of the overall food management system 1. For example, in one procedure the apparatus control system 1200 sends a “cook cycle start” signal to the master control system 40 when a cook cycle for a batch of food items is initiated. If cooking of the food items is not initiated (cook cycle start) within a predetermined amount of time, the master control system and/or the apparatus control system are programmed to send a “cook delay” alert to the master display 64 and/or to the apparatus display 1224.

In another procedure, the apparatus control system 1200 is programmed to send a “cook complete” signal to the master control system 40 indicating that cooked food items are available for transfer. If these food items are not transferred to a food holding apparatus 20 (e.g., product holding cabinet 22) in a predetermined amount of time, the master control system 40 and/or the apparatus control system 1200 are programmed to send a “transfer delay” signal to the master display 64 and/or to the display 1224.

Optionally, the master control system 40 is programmed to display on the master display 64 all or some of the information described above displayed on the food cooking device display 1224, including cook delay alerts, transfer delay alerts, cook recipe suggestions and changes, fault conditions and history, energy usage, etc. The master control system 40 and/or food cooking device control system 1200 may also be programmed to record and display other information on either or both displays 64, 1224.

In other embodiments, the master control system 40 may be combined with more than one food preparation apparatus control system 1200 to make a module in which the master control system shares information with the control system of each food preparation apparatus 6, and vice versa, as described above. In such a module, at least some of the information displayed on the display 64 of the master control system 40 is also displayed on the display 1224 of a first food preparation apparatus (e.g., the oven 10) and at least some of the information displayed on the display 64 of the master control system is also displayed on the display 1224 of a second food preparation apparatus (e.g., the fryer 12 or holding cabinet 22).

It will be observed from the foregoing that the food cooking device features described above may be incorporated into a stand-alone food preparation device, independent of the master control system 40. Alternatively, the master control system 40 and control system 1200 can be combined to make a module in which the two systems 40, 1200 communicate with one another and share information, as described above.

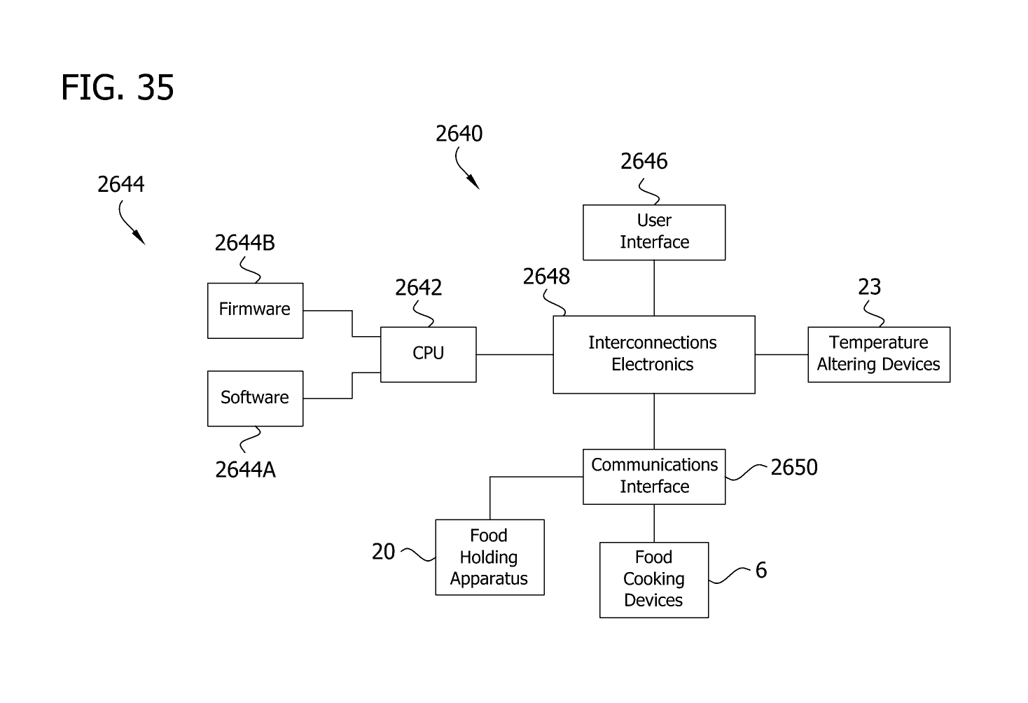

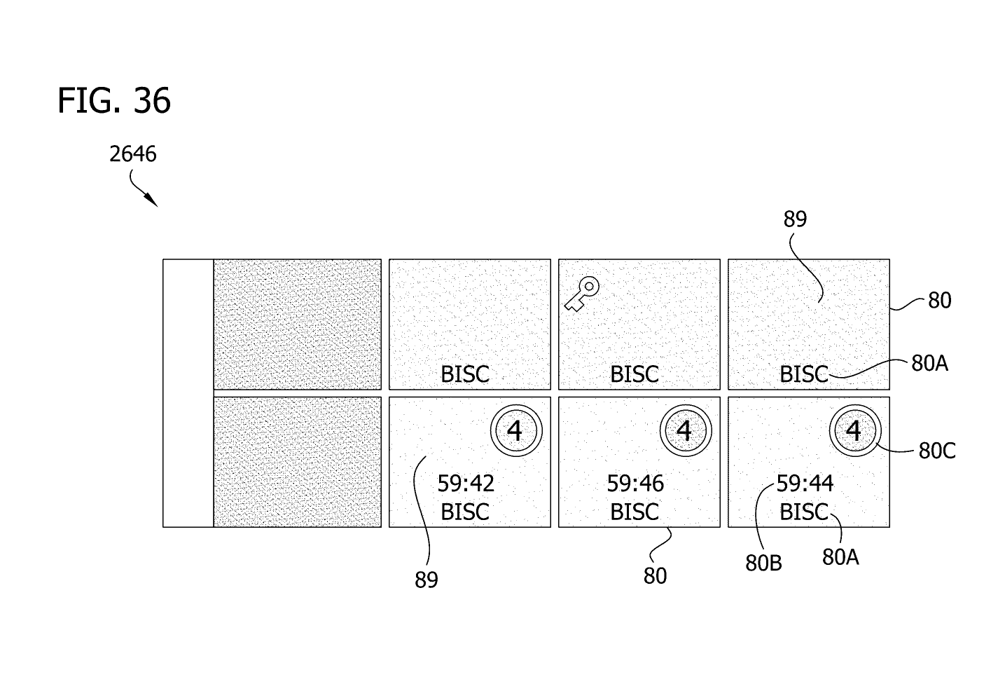

Another aspect of the present invention relates to determining whether a delay has occurred in transferring cooked food from a food cooking device 6 (e.g., the oven 10, fryer 12, etc.) to the food holding apparatus 20. Referring to FIG. 35, a food transfer management control system is shown schematically and generally designated by the reference number 2640. Components of the food transfer management control system 2640 may be part of the master control system 40, a product holding apparatus 20, and/or other apparatus of the system 1, such as the food cooking devices 6, point-of-sale device 24, local computer 26, remote computer 28, tablet 30, hand-held mobile computer 32, control system 1200, etc. The food transfer management control system 2640 includes a central processing unit 2642 (“CPU” or broadly “controller”) including one or more processors (e.g., heat control processor), a tangible storage medium 2644 (e.g., including forms of storage such as software 2644A and firmware 2644B), and a user interface 2646. The CPU 2642 may be a microprocessor or the like. The food transfer management control system 2640 includes interconnection electronics 2648 that operatively connect the various components of the food transfer management system 2640 and may connect the control system via a communications interface 2650 with other control apparatus 4 and/or food preparation apparatus 2. The communications interface 2648 may include wired or wireless communications devices or connectors (e.g., USB flash drive port, other types of data ports, modems, wireless signal transmitters/receivers, etc.). The controller 2642 is adapted for reading and executing processor executable instructions stored in the storage medium 2644, and is responsive to the user interface 2646, for controlling the various components and systems of the food transfer management system 2640. A user can enter or modify instructions stored on the storage medium 2644 via the user interface 2646 and/or via a communications interface 2650. In the illustrated embodiment, the user interface 2646 includes a touch screen display 2664 (e.g., such as the touch screen display 64 described above), portions of which are shown in FIGS. 36-38. Other types of user interfaces may be used without departing from the present invention. The user interface 2646 provides command signals via the interconnection electronics 2648 to the CPU 2642. The command signals can include changes to the parameters stored in the tangible storage medium 2644. The CPU 2642 responds to the command signals and provides information (e.g., food status indications) and/or instructions via the interconnection electronics 2648 to the user interface 2646 to be communicated to the employees. The food transfer management control system 2640 may include one or more temperature altering devices 23, such as heat sources or heat generating devices, associated with respective holding locations 36. If the food transfer management control system 2640 is separate from or includes components separate from a food preparation apparatus control system 1200 (e.g., for the food holding apparatus 20 and/or a food cooking device 6), the food transfer management control system 2640 or components thereof may be in operative communication with the food preparation apparatus control system via the communications interface 2650.

The storage medium 2644 includes processor executable instructions for controlling the operation of the temperature altering devices 23 according to a programmed holding cycle recipe (time/heat). For example the holding cycle recipe may be a holding cycle heating recipe to deliver heat to the pre-cooked food in the respective holding location for a holding cycle. Desirably, the programmed holding cycle recipe is suitable for maintaining food in the holding apparatus 20 at a suitable condition (e.g., warm temperature) for serving to customers for an extended period of time.

The controller 2642 can determine delay in transferring food from a cooking device 6 to the food holding apparatus 20 in various ways. The tangible storage medium 2644 may include instructions for determining transfer delay as a function of a predetermined threshold transfer time and an actual transfer time. For example, the tangible storage medium may store the predetermined threshold transfer time, and the actual transfer time can be compared to the predetermined threshold transfer time to determine if it is exceeded by the actual transfer time for determining transfer delay. The predetermined threshold transfer time can be the same or be different for different types of food. For example, the tangible storage medium 2644 can store a table of threshold transfer times associated with different food types. The threshold transfer time can be pre-determined based on testing, such as testing to determine the length of time before cooked food of a particular type begins to degrade, become unsuitable for serving, reduce in temperature significantly, etc. For example, the predetermined threshold transfer time can be 0.25, 0.5, 1, 2, 3, 4, or more minutes, or any time value therebetween. The actual transfer time can be determined in various ways. The actual transfer time is time elapsed after cooking is complete and before the cooked food is held at the food holding apparatus 20. The actual transfer time can exist independent from the food ultimately being transferred to the holding apparatus 20. The tangible storage medium 2644 can include instructions for the controller 2642 to determine the actual transfer time as a function of a cooking initiated signal indicating cooking of the food has been initiated (e.g., in combination with a known or estimated cook time), and/or a cooking complete signal indicating cooking of the food is complete. For example, the cooking initiated and/or cooking complete signals may be generated by the food cooking device 6 and/or user input, such as via the user interface 2646. In addition, the controller 2642 can determine actual transfer delay as a function of other user input, such as by the user actuating a holding location display 80 of the user interface 2646 for entering food at a respective holding location of the food holding apparatus 20. For example, after a user cooks a certain type of food, the user may actuate a holding location display 80 (e.g., as described above) displaying a food type indicator 80A indicating that a certain type of food is to be held at the corresponding holding location. A holding signal indicating food is held at the holding location can be generated responsive to user input via the user interface 2646 (e.g., actuation via a respective holding location display 80) or a sensor 110 indicating food is held at the holding location. This indicates that the transfer has happened, ending the actual transfer time. It will be understood that various ways of determining the actual transfer time can be used without departing from the scope of the present invention.

Various actions may be taken when the controller 2642 determines a transfer delay. The controller 2642 records the transfer delay in the tangible storage medium 2644, such as with a time/date stamp and associated food type. If the duration of transfer delay is minimal, the controller 2642 may not alter the ordinary transfer of the cooked food to the food holding apparatus 20. However, the controller can also change the ordinary transfer of the cooked food to the food holding apparatus 20 as a function of the transfer delay. If the transfer delay is less than a predetermined transfer delay threshold (stored in the tangible storage medium 2644), the controller may permit the cooked food to be entered in the food holding apparatus 20 and provide a boost of heat to the food in the food holding apparatus. For example, the predetermined transfer delay threshold may be 1, 2, 3, 4, or more minutes. The tangible storage medium 2644 may include instructions for modifying the programmed holding cycle heating recipe (i.e., “typical” or “default” recipe) as a function of the transfer delay. The transfer delay may cause the temperature of the cooked food to fall below a temperature at which it is desirable to begin the holding cycle. The storage medium 2644 includes instructions for modifying the default holding cycle heating recipe as a function of the transfer delay. In particular, if there has been a delay in transferring the cooked food from the food cooking device 6 to the food holding apparatus 20, it may be desirable to provide a boost of heat (“turbo boost”) to the food at or near the beginning of the holding cycle. The controller 2642 can modify the programmed holding cycle heating recipe by, for example, replacing it with a holding recipe including a boost heating recipe, adjusting it to include a boost heating recipe, and/or supplementing it with a boost heating recipe. The boost heating recipe can be predetermined (stored in the tangible storage medium 2644) or be variable, such as a function of the length of transfer delay. As will be understood, the boost of heat could provide a relatively high level of heat (e.g., relative to the default holding cycle recipe) in a relatively short amount of time to reheat the food to about the temperature it would have been at had there not been a delay in transferring the food to the food holding apparatus 20.

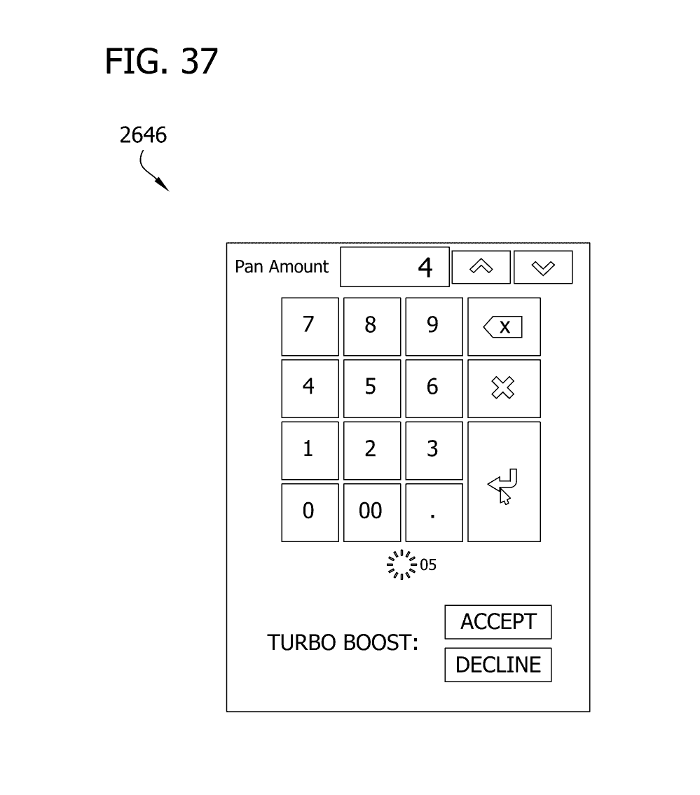

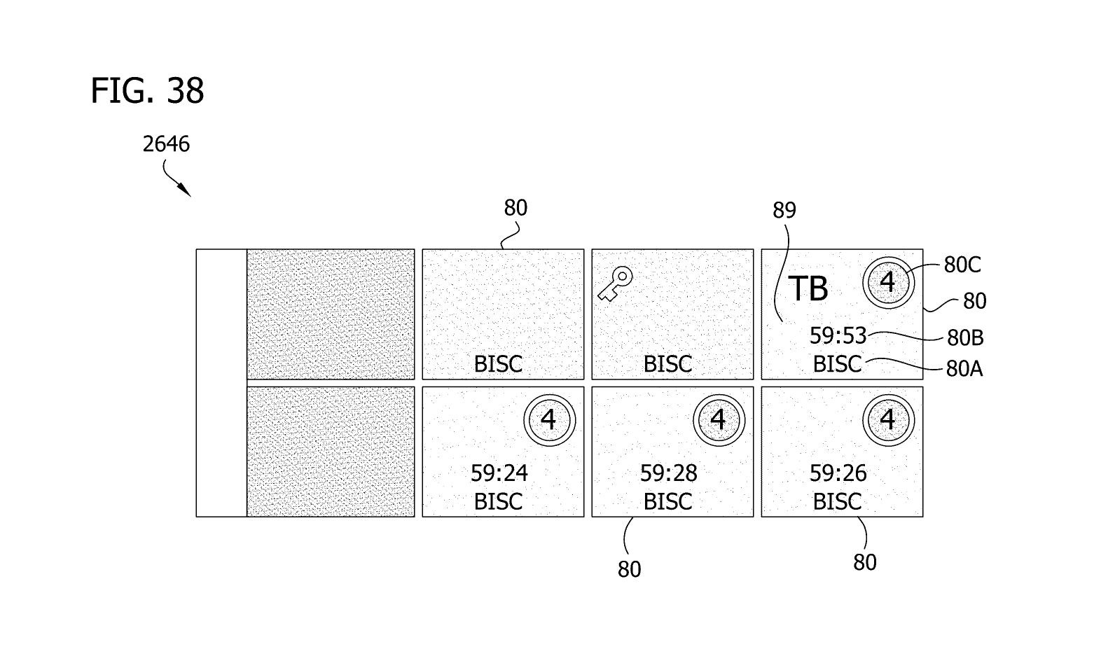

An example of boost heating based on transfer delay is illustrated by reference to FIGS. 36-38. A section of the user interface 2646 is shown in FIG. 36. Assume a batch of four biscuits has been baked, and the food transfer management control system determined there was a delay in transferring the biscuits to the food holding apparatus 20. The operator presses the button 89 associated with the top right holding compartment. In response, a prompt window shown in FIG. 37 is displayed. The window is similar in many aspects with the prompt window described above. In this embodiment, the prompt window indicates that the controller 2642 suggests modifying the default holding recipe for biscuits with the boost heating recipe and prompts the user to accept or decline the modification by actuating respective buttons. If the user accepts the modification, the recipe will be modified. For example, as shown in FIG. 38, an indicator such as “TB” may be displayed on the holding location display 80 indicating the holding recipe has been modified. Alternatively, the food transfer management control system may automatically modify the heating recipe, without prompting the operator to accept or decline the modification.

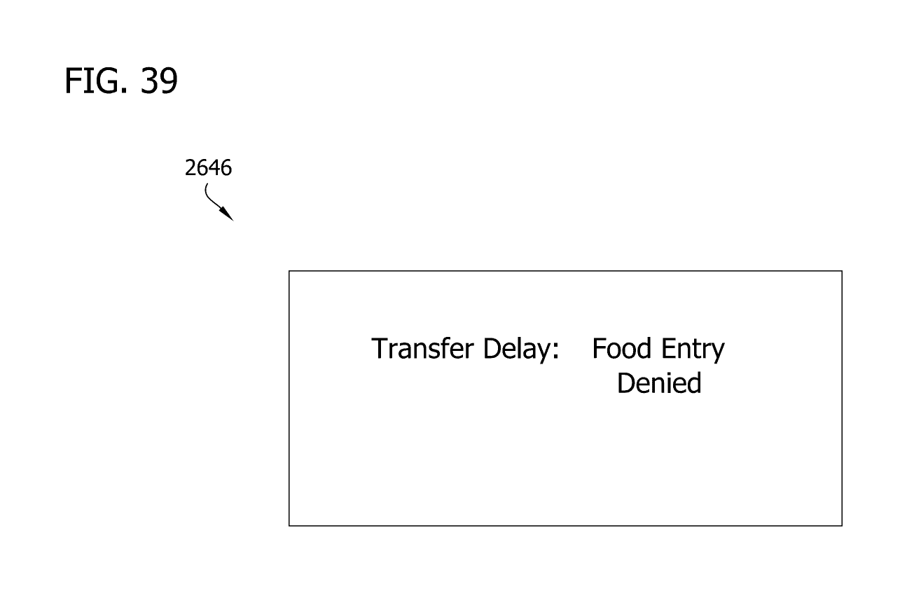

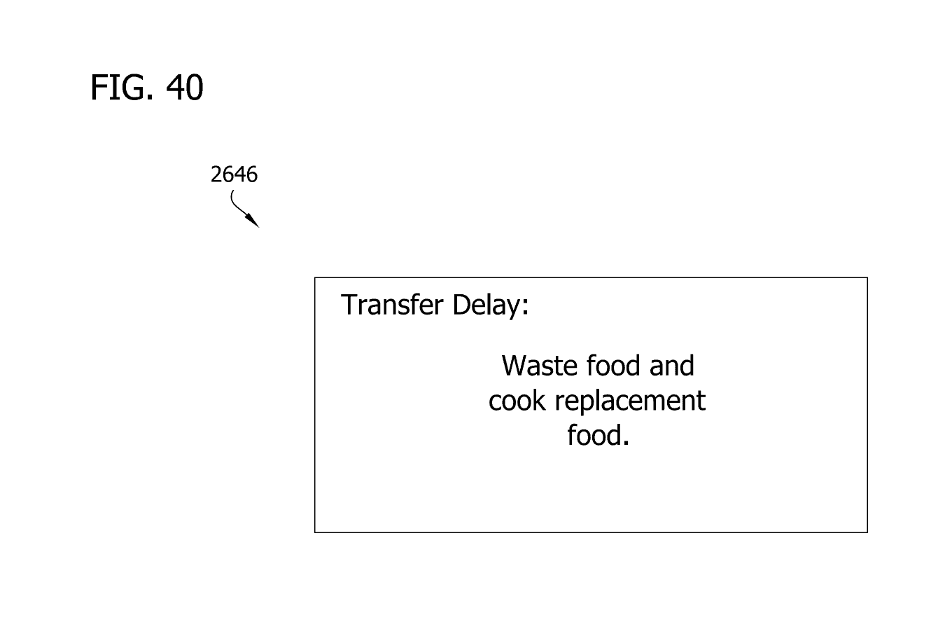

The controller 2642 may carry out other actions with respect to transfer delay, some of which will be described with reference to FIGS. 36, 39, and 40. For example, assuming the user cooked biscuits, and the transfer delay exceeds the predetermined transfer delay threshold, the controller 2642 may deny entry of the biscuits in the food holding apparatus 20 via the user interface 2646. The lengthy transfer delay may have caused the food to no longer be suitable for transferring to the food holding apparatus 20. Referring to FIG. 36, if the user attempts to enter the biscuits into the food holding apparatus 20, such as by actuating the top right biscuit holding location display 80 (having a food type indicator 80A BISC indicating biscuits are to be held in the corresponding holding location), the controller 2642 may display a message on the user interface 2646, such as shown in FIG. 39, informing the user the food cannot be entered in the holding apparatus, or otherwise denying entry of the food. Moreover, the controller 2642 can display on the user interface 2646, such as shown in FIG. 40, an instruction to waste the cooked food and/or to cook replacement food. Alternatively, the message to cook replacement food may be performed by modifying the pertinent cook list 70A, 70B, 70C to indicate an amount of that food type to be cooked. The controller 2642 may continue to deny entry of food of that type into the food holding apparatus 20 at least until cooking of replacement food has been initiated, or at least until cooking of the replacement food is complete, either of which may be determined by a signal from the food cooking device 6 and/or user input via the user interface 2646. This hinders the user from cheating by entering the food that should be wasted in the food holding apparatus 20 as the replacement food.

The Title, Field of Invention, and Background are provided to help the reader quickly ascertain the nature of the technical disclosure. They are submitted with the understanding that they will not be used to interpret or limit the scope or meaning of the claims. They are provided to introduce a selection of concepts in simplified form that are further described in the Detailed Description. The Title, Field of Invention, and Background are not intended to identify key features or essential features of the claimed subject matter, nor is it intended to be used as an aid in determining the claimed subject matter.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the aspects of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the aspects of the invention may include different processor-executable instructions or components having more or less functionality than illustrated and described herein.

The order of execution or performance of the operations in embodiments of the aspects of the invention illustrated and described herein is not essential, unless otherwise specified. That is, the operations may be performed in any order, unless otherwise specified, and embodiments of the aspects of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention is not limited in its application to the details of construction and the arrangement of components set forth in the description or illustrated in the drawings. The aspects of the invention are capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and methods without departing from the scope of aspects of the invention. In the preceding specification, various embodiments have been described with reference to the accompanying drawings. It will, however, be evident that various modifications and changes may be made thereto, and additional embodiments may be implemented, without departing from the broader scope of the aspects of the invention as set forth in the claims that follow. The specification and drawings are accordingly to be regarded in an illustrative rather than restrictive sense.

### OTHER STATEMENTS OF INVENTION

The following are statement of invention described in the present application. Although some of the following statements are not currently presented as claims, the statements are believed to be patentable and may subsequently be presented as claims. Associated methods, such as methods corresponding to statements of apparatus or systems below, are also believed to be patentable and may subsequently be presented as claims.

A1. A food preparation control module, comprising

a master control system including a processor and a tangible storage medium having processor executable instructions,
said master control system including a first display for displaying information relating to food items to be cooked by cooking apparatus and to be held by food holding apparatus, and a food preparation apparatus control system including a processor and a tangible storage medium having processor executable instructions,
said food preparation apparatus control system including a second display, and
said master control system and said food preparation apparatus control system communicating with one another such that at least some information displayed on the first display is displayed on the second display.

A2. The food preparation control module of claim 1, wherein said at least some information includes a list prioritizing different types of food items according to a sequence in which they are to be prepared by the food preparation apparatus.

A3. The food preparation control module of claim 2, wherein said food preparation apparatus is cooking apparatus, and wherein the list is a cook list which prioritizes the food items according to a sequence in which they are to be cooked.

A4. The food preparation control module of claim 1, wherein said first and/or second display includes an operator input for changing a cook recipe for a food item being cooked by the food preparation apparatus.

A5. The food preparation control module of claim 4, wherein the cook recipe comprises a number of different cook cycle phases and, for each cook cycle phase, a cook time, a cook temperature, and an on/off condition for one or more heat sources of the food preparation apparatus.

A6. The food preparation control module of claim 1, wherein changes to said at least some information are displayed substantially simultaneously on the first and second displays.

A7. The food preparation control module of claim 1, wherein said at least some information includes one or more of the following types of information: cook delay alerts, transfer delay alerts, cook recipe suggestions and changes, fault conditions and history, and energy usage.

A8. The food preparation control module of claim 1, wherein said food preparation apparatus control system is a first food preparation apparatus control system, said control module further comprising a second food preparation apparatus control system including a processor and a tangible storage medium having processor executable instructions, said second food preparation apparatus control system including a third display, and wherein said master control system communicates with said first and second food preparation apparatus control systems such that at least some of the information displayed on the first display is displayed on the second display and at least some of the information displayed on the first display is displayed on third display.

B1. A computer executable method for managing transfer of cooked food in a food preparation establishment, the method including:

cooking food with a food cooking device,
operating a cooked food transfer management controller to monitor actual cooked food transfer time elapsed before the cooked food is held at a cooked food holding location of a cooked food holding apparatus,
determining, with the cooked food transfer management controller, a cooked food transfer delay as a function of a comparison of the actual cooked food transfer time and a predetermined threshold cooked food transfer time.

B2. A method as set forth in claim B1 wherein the cooked food transfer management controller determines the cooked food transfer delay as a function of the actual cooked food transfer time exceeding the predetermined threshold cooked food transfer time.

B3. A method as set forth in claim B1 further including modifying a default cooked food holding cycle heating recipe as a function of the cooked food transfer delay and operating a heat-generating device at the cooked food holding location according to the modified default cooked food holding cycle heating recipe.

B4. A method as set forth in claim B3 wherein the default cooked food holding cycle heating recipe is modified to provide a boost of heat to the cooked food at or near the beginning of the cooked food holding cycle.

C1. A food cooking system comprising:

a cooking device configured for cooking food, and
a cooking device control system associated with the cooking device, the cooking device control system including a processor, a tangible storage medium storing processor executable instructions, and a user interface for receiving input from a user,
said tangible storage medium storing food cook recipe instructions for a food item type, said instructions, when executed by the processor, operating the cooking device according to a cook recipe comprising a number of different cook cycle phases to cook the food item type in the cooking device,
wherein said user interface is configured for changing the cook recipe instructions for the food item type, and, for each cook cycle phase, at least one of a cook time, a cook temperature, and an on/off condition for one of more heat sources, is selectively modifiable via the user interface.

What is claimed is:

1. A food cooking system comprising:
a master control system including a processor, a tangible storage medium storing processor executable instructions, and a master control user interface displaying a variable cook list listing at least one food item type to be cooked, the variable cook list changing based on need for food, the variable cook list having a highest priority position for indicating a food item type of highest priority to be cooked, and
a cooking device operatively connected to the master control system, the cooking device being configured for cooking the at least one food item type, the cooking device including a processor, a tangible storage medium storing processor executable instructions, and a user interface, the cooking device user interface displaying the variable cook list listing the at least one food item type to be cooked, the cooking device user interface including at least one cook recipe button for causing the cooking device to execute a cook recipe associated with the at least one food item type to cook the at least one food item type.

2. A food cooking system as set forth in claim 1 wherein the variable cook list displayed by the master control user interface and the cooking device user interface lists at least a first food item type and a second food item type, the first food item type or the second food item type being in the highest priority position based on need for the first and second food item types.

3. A food cooking system as set forth in claim 1 wherein changes to the variable cook list are updated on the master control user interface and the cooking device user interface substantially simultaneously.

4. A food cooking system as set forth in claim 1 wherein the cooking device is a first cooking device and the master control user interface displays a master cook list including multiple cook list sections associated with different cooking devices, one of said cook list sections including the variable cook list for said first cooking device.

5. A food cooking system as set forth in claim 1 wherein the cooking device user interface has a recipe button section including the at least one cook recipe button, the recipe button section changing in appearance as a function of the food item type in the highest priority position of the variable cook list.

6. A food cooking system as set forth in claim 5 wherein the at least one cook recipe button changes in appearance as a function of the food item type in the highest priority position of the variable cook list.

7. A food cooking system as set forth in claim 6 wherein the at least one cook recipe button changes in appearance by flashing to draw attention of a user.

8. A food cooking system as set forth in claim 6 wherein the at least one cook recipe button changes color as a function of the food item type in the highest priority position of the variable cook list.

9. A food cooking system as set forth in claim 5 wherein the at least one cook recipe button includes a series of cook recipe buttons associated with respective recipes for cooking different food items types, the appearance of the series of cook recipe buttons changing as a function of the food item type in the highest priority position of the variable cook list.

10. A food cooking system as set forth in claim 9 wherein the recipe button section changes in appearance to emphasize to the user the cook recipe button associated with a cook recipe for cooking the food item type in the highest priority position on the variable cook list.

11. A food cooking system as set forth in claim 10 wherein the recipe button section is separate from the variable cook list.

12. A food cooking system as set forth in claim 1 wherein an aspect of the cooking device user interface other than the variable cook list changes as a function of the food item listed in the highest priority position.

13. A food cooking system as set forth in claim 1 wherein the cooking device user interface comprises a touch screen display displaying the variable cook list and having the at least one cook recipe button.

14. A food cooking system as set forth in claim 1 wherein the at least one cook recipe button is positioned next to the variable cook list.

15. A food cooking system as set forth in claim 1 wherein the cooking device user interface is mounted on the cooking device.

16. A food cooking system as set forth in claim 1 wherein the master control system monitors inventory of cooked food items cooked by the cooking device and varies the variable cook list as a function of the inventory of the cooked food items cooked by the cooking device.

17. A food cooking system as set forth in claim 1 wherein at least one of the master control user interface and the cooking device user interface is configured for changing a stored cook recipe for a food item type.

18. A food cooking system as set forth in claim 17 wherein the cook recipe comprises a number of different cook cycle phases and wherein, for each cook cycle phase, a cook time and a cook temperature are selectively modifiable.

19. A food cooking system as set forth in claim 1 wherein the master control system and the cooking device communicate with each other such that at least some information displayed on the master control user interface is displayed on the cooking device user interface, the at least some information including: at least one of transfer delay alerts, cook recipe changes, fault conditions, fault history, and energy usage.

20. A food preparation control module comprising:
a master control system including a processor and a tangible storage medium having processor executable instructions,
said master control system including a first display for displaying information relating to food items to be cooked by cooking apparatus and to be held by food holding apparatus, and
a food preparation apparatus control system including a processor and a tangible storage medium having processor executable instructions,
said food preparation apparatus control system including a second display, and
said master control system and said food preparation apparatus control system being in communication with each other such that at least some information displayed on the first display is displayed on the second display.
